(19) United States
(12) Patent Application Publication
(10) Pub. No.: US 2020/0213619 A1
(43) Pub. Date: Jul. 2, 2020

(54) VIDEO CODING APPARATUS AND VIDEO DECODING APPARATUS, FILTER DEVICE

(71) Applicant: Sharp Kabushiki Kaisha, Sakai City, Osaka (JP)

(72) Inventors: Tomoko AONO, Sakai City (JP); Tomohiro IKAI, Sakai City (JP)

(21) Appl. No.: 16/614,810

(22) PCT Filed: May 22, 2018
(86) PCT No.: PCT/JP2018/019654

§ 371 Date: Nov. 19, 2019

(30) Foreign Application Priority Data
May 26, 2017 (JP) 2017-104368

(51) Int. Cl. H04N 19/593; H04N 19/182; H04N 19/176; H04N 19/124; H04N 19/59

(52) U.S. Cl. CPC H04N 19/593; H04N 19/182; H04N 19/59; H04N 19/124; H04N 19/176

(57) ABSTRACT

For a reference pixel of a block on an upper side of a target block, in a chrominance component, one pixel (first reference pixel) for every two pixels of the target block is stored in a memory, and a pixel that is not stored in the memory (second reference pixel) is derived by interpolation from the first reference pixel, a predictor refers to the first reference pixel and the second reference pixel and calculates an intra prediction value of each pixel of the chrominance component of the target block.

### TECHNICAL FIELD

The present invention relates to an image decoding apparatus and an image coding apparatus.

### BACKGROUND ART

An image coding apparatus which generates coded data by coding a video, and an image decoding apparatus which generates decoded images by decoding the coded data are used to transmit or record a video efficiently.

For example, specific video coding schemes include methods suggested in H.264/AVC or High-Efficiency Video Coding (HEVC).

In such a video coding scheme, images (pictures) constituting a video are managed by a hierarchy structure including slices obtained by splitting images, Coding Tree Units (CTUs) obtained by splitting slices, units of coding (also referred to as Coding Unit (CUs)) obtained by splitting the coding tree units, prediction units (PUs) which are blocks obtained by splitting coding units, and transform units (TUs), and are coded/decoded for each CU.

In such a video coding scheme, usually, a prediction image is generated based on local decoded images obtained by coding/decoding input images, and prediction residual (also sometimes referred to as “difference images” or “residual images”) obtained by subtracting the prediction images from input images (original image) are coded. Generation methods of the prediction images include an inter-picture prediction (an inter prediction) and an intra-picture prediction (intra prediction) (NPL 1).

In addition, for a format of an input and output images, a 4:2:0 format in which a resolution of a chrominance component is dropped to one fourth that of a luminance component, is generally used. However, in recent years, high image quality is demanded particularly around commercial apparatuses, and a 4:4:4 format in which the resolutions of the luminance component and the chrominance component are equal to each other has been increasing in use. FIG. 7 illustrates pixel positions in the 4:2:0 and 4:4:4 formats. The 4:4:4 format in FIG. 7(a) is a format in which the luminance component (Y) and the chrominance component (Cb, Cr) are located at the same pixel position in both horizontal and vertical directions and have the same resolution. The 4:2:0 format in FIG. 7(b) is a format in which the number of pixel positions at each of which the chrominance component is present is ½ in both the horizontal and vertical directions, that is, the resolution is halved, in comparison with that of the luminance component. Therefore, some of tools used in the image coding or decoding process require a larger memory in a case of handling the 4:4:4 format than that required in the 4:2:0 format (NPL 2).

In the future, the use of the 4:4:4 format is expected to expand from the commercial apparatuses to consumer apparatuses in conjunction with increase in a transmission capacity of communication and a storage capacity of a recording medium.

### CITATION LIST

### Non Patent Literature

NPL 1: “Algorithm Description of Joint Exploration Test Model 5”, JVET-E1001, Joint Video Exploration Team (JVET) of ITU-T SG 16 WP 3 and ISO/IEC JTC 1/SC 29/WG 11, 12-20 Jan. 2017
NPL 2: ITU-T H.265 (April 2015) SERIES H: AUDIOVISUAL AND MULTIMEDIA SYSTEMS Infrastructure of audiovisual services—Coding of moving video High efficiency video coding

### SUMMARY OF INVENTION

### Technical Problem

As described above, some of the tools used in the image coding or decoding process require a larger memory in a case of handling the 4:4:4 format than the memory required in the 4:2:0 format. Therefore, an apparatus compliant only with the 4:2:0 format cannot decode contents of the 4:4:4 format. NPL 2 discloses a method in which by storing profile information in contents (coded data) and signaling an image decoding apparatus of whether coded data are in the 4:4:4 format or the 4:2:0 format, it is determined beforehand whether the image decoding apparatus can regenerate the coded data, and only the coded data that can be regenerated can be decoded.

However, as the spread of the contents of the 4:4:4 format progresses, there is an increasing demand for a 4:2:0 format-compliant apparatus to decode the contents of the 4:4:4 format. The largest cause that the 4:2:0 format-compliant image decoding apparatus cannot decode the coded data of the 4:4:4 format is a size of a line memory for storing a reference image. Since the consumer apparatus has only a minimum necessary memory in many cases, in a case of decoding the coded data of the 4:4:4 format, the 4:2:0 format-compliant image decoding apparatus has only half the necessary amount of the line memory of the chrominance component.

The present invention has been made in view of the above-described problems and an object of the present invention is to make a line memory size, required for a decoding process, common in a 4:2:0 format and a 4:4:4 format, and to reduce the memory size required for a case that the coded data of the 4:4:4 format is regenerated.

### Solution to Problem

An image coding apparatus according to an aspect of the present invention includes: a unit configured to split a picture of the input video to a block including multiple pixels; a predictor configured to, by taking the block as a unit, refer to a pixel (a reference pixel) of an adjacent block of a target block, perform an intra prediction, and calculate a prediction pixel value; a unit configured to subtract the prediction pixel value from the input video and calculate a prediction error; a unit configured to perform transformation and quantization on the prediction error and output a quantized transform coefficient; and a unit configured to perform variable-length coding on the quantized transform coefficient, in which the predictor refers to a pixel of a block on a left side and a pixel of a block on an upper side, of the target block on which the intra prediction is performed, refers to, in the chrominance component, for a reference pixel of the block on the upper side, one pixel (a first reference pixel) for every two pixels of the target block, and derives a remaining one pixel (a second reference pixel) by interpolation from the first reference pixel, and the predictor refers to the first reference pixel and the second reference pixel and calculates an intra prediction value of each pixel of the chrominance component of the target block.

An image decoding apparatus according to an aspect of the present invention includes: a unit configured to, by taking a block including multiple pixels as a processing unit, perform variable-length decoding on coded data and output a quantized transform coefficient; a unit configured to perform inverse quantization and inverse transformation on the quantized transform coefficient and output a prediction error; a predictor configured to, by taking the block as a unit, refer to a pixel (a reference pixel) of an adjacent block of a target block, perform an intra prediction, and calculate a prediction pixel value; and a unit configured to add the prediction pixel value and the prediction error, in which the predictor refers to a pixel of a block on a left side and a pixel of a block on an upper side, of the target block on which the intra prediction is performed, refers to, in the chrominance component, for a reference pixel of the block on the upper side, one pixel (a first reference pixel) for every two pixels of the target block, and derives a remaining one pixel (a second reference pixel) by interpolation from the first reference pixel, and the predictor refers to the first reference pixel and the second reference pixel and calculates an intra prediction value of each pixel of the chrominance component of the target block.

### Advantageous Effects of Invention

According to an aspect of the present invention, a 4:2:0 format-compliant image decoding apparatus can decode coded data of a 4:4:4 format.

### BRIEF DESCRIPTION OF DRAWINGS

FIG. 1 is a schematic diagram illustrating a configuration of an image transmission system according to an embodiment of the present invention.

FIG. 2 is a diagram illustrating a hierarchy structure of data of a coding stream according to an embodiment of the present invention.

FIG. 3 is a diagram illustrating patterns of PU split modes. (a) to (h) of FIG. 3 illustrate partition shapes in cases that PU split modes are 2N×2N, 2N×N, 2N×nU, 2N×nD, N×2N, nL×2N, nR×2N, and N×N, respectively.

FIG. 4 is a conceptual diagram illustrating an example of reference pictures and reference picture lists.

FIG. 5 is a block diagram illustrating a configuration of an image decoding apparatus according to an embodiment of the present invention.

FIG. 6 is block diagram illustrating a configuration of an image coding apparatus according to an embodiment of the present invention.

FIG. 7 is a diagram illustrating 4:2:0 and 4:4:4 formats.

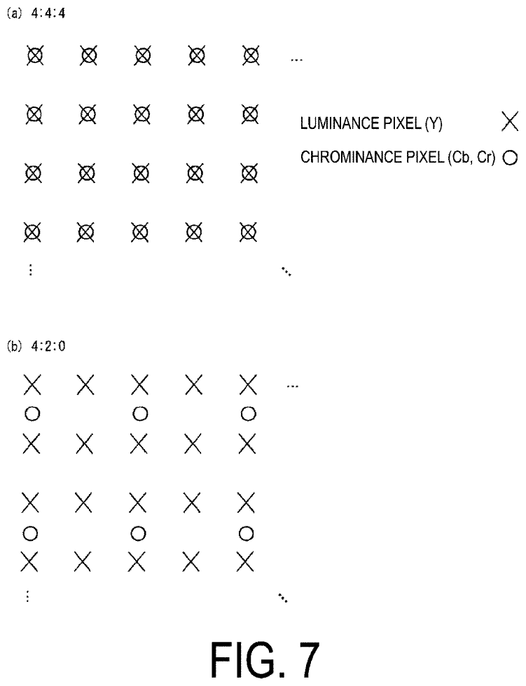

FIG. 8 is a diagram illustrating configurations of a transmitting apparatus equipped with the image coding apparatus and a receiving apparatus equipped with the image decoding apparatus according to an embodiment of the present invention. (a) of FIG. 8 illustrates the transmitting apparatus equipped with the image coding apparatus, and (b) of FIG. 8 illustrates the receiving apparatus equipped with the image decoding apparatus.

FIG. 9 is a diagram illustrating configurations of a recording apparatus equipped with the image coding apparatus and a regeneration apparatus equipped with the image decoding apparatus according to an embodiment of the present invention. (a) of FIG. 9 illustrates the recording apparatus equipped with the image coding apparatus, and (b) of FIG. 9 illustrates the regeneration apparatus equipped with the image decoding apparatus.

FIG. 10 is a diagram illustrating a target pixel and a reference pixel of an intra prediction.

FIG. 11 is a diagram illustrating a reference memory of the intra prediction.

FIG. 12A is a diagram illustrating a target pixel and a reference pixel of a loop filter.

FIG. 12B is a diagram illustrating the target pixel and the reference pixel of the loop filter.

FIG. 13 is a diagram illustrating a reference memory of the loop filter.

FIG. 14 is a flowchart illustrating access to the reference memory.

FIG. 15 is a diagram illustrating a problem of a reference memory for storing a 4:2:0 format image.

FIG. 16A is a diagram illustrating a relationship between an internal memory and the reference memory in the intra prediction.

FIG. 16B is a diagram illustrating a relationship between the internal memory and the reference memory in the intra prediction.

FIG. 17 is a flowchart illustrating access to the reference memory according to an embodiment of the present invention.

FIG. 18 is a diagram illustrating a pixel stored in the reference memory according to an embodiment of the present invention.

FIG. 19 is a diagram illustrating an interpolation method of pixels not stored in the reference memory according to an embodiment of the present invention.

FIG. 20 is a diagram illustrating an example of the reference memory of the loop filter.

FIG. 21 is a diagram illustrating a storing method of an image to the reference memory according to an embodiment of the present invention.

FIG. 22 is a diagram illustrating a filtering method of the loop filter according to an embodiment of the present invention.

FIG. 23 is a diagram illustrating another filtering method of the loop filter according to an embodiment of the present invention.

FIG. 24 is another diagram illustrating a filtering method of an ALF according to an embodiment of the present invention.

FIG. 25 is a diagram illustrating a filter shape of the ALF.

FIG. 26 is a diagram illustrating a relationship between a CTU and a CU.

FIG. 27 is a flowchart illustrating some operations according to an embodiment of the present invention.

FIG. 28 is a diagram illustrating a reference memory of the ALF according to an embodiment of the present invention.

### DESCRIPTION OF EMBODIMENTS

### Embodiment 1

Hereinafter, embodiments of the present invention are described with reference to the drawings.

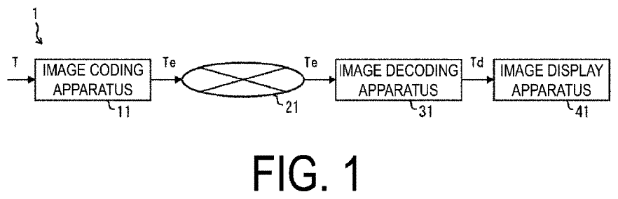

FIG. 1 is a schematic diagram illustrating a configuration of an image transmission system 1 according to the present embodiment.

The image transmission system 1 is a system configured to transmit codes of a coding target image having been coded, decode the transmitted codes, and display an image. The image transmission system 1 is configured to include an image coding apparatus 11, a network 21, an image decoding apparatus 31, and an image display apparatus 41.

An image T indicating an image of a single layer or multiple layers is input to the image coding apparatus 11. A layer is a concept used to distinguish multiple pictures in a case that there are one or more pictures to configure a certain time. For example, coding an identical picture in multiple layers having different image qualities and resolutions is scalable coding, and coding pictures having different viewpoints in multiple layers is view scalable coding. In a case of performing a prediction (an inter-layer prediction, an inter-view prediction) between pictures in multiple layers, coding efficiency greatly improves. In a case of not performing a prediction (simulcast), coded data can be compiled.

The network 21 transmits a coding stream Te generated by the image coding apparatus 11 to the image decoding apparatus 31. The network 21 is the Internet (internet), Wide Area Network (WAN), Local Area Network (LAN), or combinations thereof. The network 21 is not necessarily a bidirectional communication network, but may be a unidirectional communication network configured to transmit broadcast waves such as digital terrestrial television broadcasting and satellite broadcasting. The network 21 may be substituted by a storage medium that records the coding stream Te, such as Digital Versatile Disc (DVD) and Blue-ray Disc (BD: registered trademark).

The image decoding apparatus 31 decodes each of the coding streams Te transmitted by the network 21, and generates one or multiple decoded images Td.

The image display apparatus 41 displays all or part of one or multiple decoded images Td generated by the image decoding apparatus 31. For example, the image display apparatus 41 includes a display device such as a liquid crystal display and an organic Electro-luminescence (EL) display. In spacial scalable coding and SNR scalable coding, in a case that the image decoding apparatus 31 and the image display apparatus 41 have high processing capability, an enhanced layer image having high image quality is displayed, and in a case of having lower processing capability, a base layer image which does not require as high processing capability and display capability as an enhanced layer is displayed.

### Operator

Operators used herein will be described below.

>> is a right bit shift, << is a left bit shift, & is a bitwise AND, | is a bitwise OR, and |= is an OR assignment operator.

x ? y: z is a ternary operator to take y in a case that x is true (other than 0), and take z in a case that x is false (0).

Clip3 (a, b, c) is a function to clip c in a value equal to or greater than a and equal to or less than b, and a function to return a in a case that c is less than a (c<a), return b in a case that c is greater than b (c>b), and return c otherwise (however, a is equal to or less than b (a<=b)).

### Structure of Coding Stream Te

Prior to the detailed description of the image coding apparatus 11 and the image decoding apparatus 31 according to the present embodiment, the data structure of the coding stream Te generated by the image coding apparatus 11 and decoded by the image decoding apparatus 31 will be described.

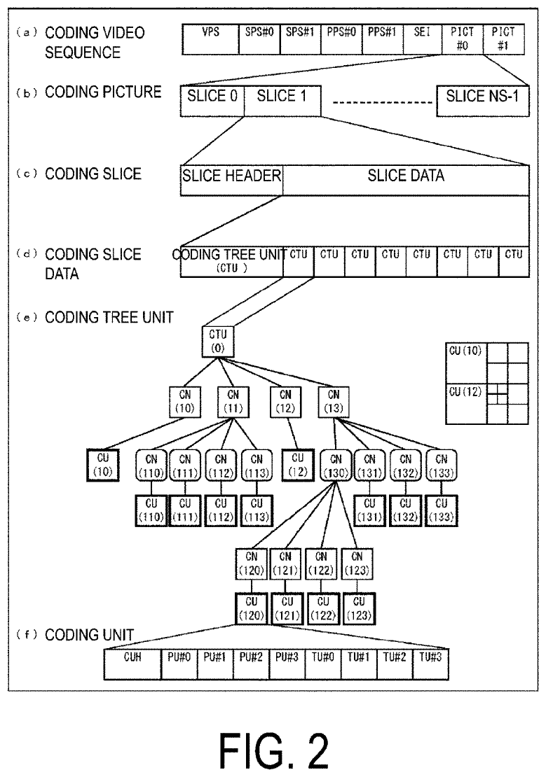

FIG. 2 is a diagram illustrating the hierarchy structure of data in the coding stream Te. The coding stream Te includes a sequence and multiple pictures constituting a sequence illustratively. (a) to 2(f) of FIG. 2 are diagrams indicating a coding video sequence prescribing a sequence SEQ, a coding picture prescribing a picture PICT, a coding slice prescribing a slice S, a coding slice data prescribing slice data, a coding tree unit included in coding slice data, and coding units (CUs) included in a coding tree unit, respectively.

### Coding Video Sequence

In the coding video sequence, a set of data referred to by the image decoding apparatus 31 to decode the sequence SEQ of a processing target is prescribed. As illustrated in (a) of FIG. 2, the sequence SEQ includes a Video Parameter Set, a Sequence Parameter Set SPS, a Picture Parameter Set PPS, a picture PICT, and Supplemental Enhancement Information SEI. Here, a value indicated after # indicates a layer ID. In FIG. 2, although an example is illustrated where coded data of #0 and #1, in other words, a layer 0 and a layer 1 exist, types of layers and the number of layers do not depend on this.

In the video parameter set VPS, in a video including multiple layers, a set of coding parameters common to multiple videos and a set of coding parameters associated with multiple layers and an individual layer included in a video are prescribed.

In the sequence parameter set SPS, a set of coding parameters referred to by the image decoding apparatus 31 to decode a target sequence is prescribed. For example, width and height of a picture are prescribed. Note that multiple SPSs may exist. In that case, any of multiple SPSs is selected from the PPS.

In the picture parameter set PPS, a set of coding parameters referred to by the image decoding apparatus 31 to decode each picture in a target sequence is prescribed. For example, a reference value (pic_init_qp_minus26) of a quantization step size used for decoding of a picture and a flag (weighted_pred_flag) indicating an application of a weighted prediction are included. Note that multiple PPSs may exist. In that case, any of multiple PPSs is selected from each picture in a target sequence.

### Coding Picture

In the coding picture, a set of data referred to by the image decoding apparatus 31 to decode the picture PICT of a processing target is prescribed. As illustrated in (b) of FIG. 2, the picture PICT includes slices S0 to S_{NS-1} (NS is the total number of slices included in the picture PICT).

Note that in a case where it is not necessary to distinguish the slices S0 to S_{NS-1} below, subscripts of reference signs may be omitted and described. The same applies to other data included in the coding stream Te described below and described with an added subscript.

### Coding Slice

In the coding slice, a set of data referred to by the image decoding apparatus 31 to decode the slice S of a processing target is prescribed. As illustrated in (c) of FIG. 2, the slice S includes a slice header SH and a slice data SDATA.

The slice header SH includes a coding parameter group referred to by the image decoding apparatus 31 to determine a decoding method of a target slice. Slice type specification information (slice_type) to specify a slice type is one example of a coding parameter included in the slice header SH.

Examples of slice types that can be specified by the slice type specification information include (1) I slice using only an intra prediction in coding, (2) P slice using a unidirectional prediction or an intra prediction in coding, and (3) B slice using a unidirectional prediction, a bidirectional prediction, or an intra prediction in coding, and the like. Note that the inter prediction is not limited to the uni-prediction or the bi-prediction, and a greater number of reference pictures may be used to generate the prediction image. Hereinafter, in a case of being referred to as the P or B slice, a slice including a block for which the inter prediction can be used is indicated.

Note that, the slice header SH may include a reference (pic_parameter_set_id) to the picture parameter set PPS included in the coding video sequence.

### Coding Slice Data

In the coding slice data, a set of data referred to by the image decoding apparatus 31 to decode the slice data SDATA of a processing target is prescribed. As illustrated in (d) of FIG. 2, the slice data SDATA includes Coding Tree Units (CTUs, CTU blocks). The CTU is a block of a fixed size (for example, 64×64) constituting a slice, and may be referred to as a Largest Coding Unit (LCU).

### Coding Tree Unit

As illustrated in (e) of FIG. 2, a set of data referred to by the image decoding apparatus 31 to decode a coding tree unit of a processing target is prescribed. A coding tree unit is split, by recursive quad tree split (QT split) or binary tree split (BT split), into Coding Units (CUs), each of which is a basic unit of coding processing. A tree structure obtained by the recursive quad tree split or binary tree split is referred to as a Coding Tree (CT), and nodes of the tree structure are referred to as Coding Nodes (CN). Intermediate nodes of the quad tree and the binary tree are coding nodes, and the coding tree unit itself is also prescribed as the highest coding node.

The CT includes, as CT information, a QT split flag (cu_split_flag) indicating whether to perform a QT split and a BT split mode (split_bt_mode) indicating a split method of a BT split. cu_split_flag and/or split_bt_mode are transmitted for each coding node CN. In a case that cu_split_flag is 1, the coding node CN is split into four coding node CNs. In a case that cu_split_flag is 0, in a case that split_bt_mode is 1, the coding node CN is split horizontally into two coding nodes CNs. In a case that split_bt_mode is 2, the coding node CN is split vertically into two coding nodes CNs. In a case that split_bt_mode is 0, the coding node CN is not split, and has one coding unit CU as a node. The coding unit CU is an end node (leaf node) of the coding nodes, and is not split anymore.

Furthermore, in a case that a size of the coding tree unit CTU is 64×64 pixels, a size of the coding unit can take any of 64×64 pixels, 64×32 pixels, 32×64 pixels, 32×32 pixels, 64×16 pixels, 16×64 pixels, 32×16 pixels, 16×32 pixels, 16×16 pixels, 64×8 pixels, 8×64 pixels, 32×8 pixels, 8×32 pixels, 16×8 pixels, 8×16 pixels, 8×8 pixels, 64×4 pixels, 4×64 pixels, 32×4 pixels, 4×32 pixels, 16×4 pixels, 4×16 pixels, 8×4 pixels, 4×8 pixels, and 4×4 pixels.

### Coding Unit

As illustrated in (f) of FIG. 2, a set of data referred to by the image decoding apparatus 31 to decode the coding unit of a processing target is prescribed. Specifically, the coding unit includes a prediction tree, a transform tree, and a CU header CUH. In the CU header, a prediction mode, a split method (PU split mode), and the like are prescribed.

In the prediction tree, a prediction parameter (a reference picture index, a motion vector, and the like) of each prediction unit (PU) where the coding unit is split into one or multiple is prescribed. In another expression, the prediction unit is one or multiple non-overlapping regions constituting the coding unit. The prediction tree includes one or multiple prediction units obtained by the above-mentioned split. Note that, in the following, a unit of prediction where the prediction unit is further split is referred to as a “subblock”. The subblock includes multiple pixels. In a case that the sizes of the prediction unit and the subblock are the same, there is one subblock in the prediction unit. In a case that the prediction unit is larger than the size of the subblock, the prediction unit is split into subblocks. For example, in a case that the prediction unit is 8×8, and the subblock is 4×4, the prediction unit is split into four subblocks formed by horizontal split into two and vertical split into two.

The prediction processing may be performed for each of these prediction units (subblocks).

Generally speaking, there are two types of splits in the prediction tree, including a case of an intra prediction and a case of an inter prediction. The intra prediction is a prediction in an identical picture, and the inter prediction refers to a prediction processing performed between mutually different pictures (for example, between display times, and between layer images).

In a case of an intra prediction, the split method has 2N×2N (the same size as the coding unit) and N×N.

In a case of an inter prediction, the split method includes coding by a PU split mode (part_mode) of the coded data, and includes 2N×2N (the same size as the coding unit), 2N×N, 2N×nU, 2N×nD, N×2N, nL×2N, nR×2N and N×N, and the like. Note that 2N×N and N×2N indicate a symmetric split of 1:1, and

2N×nU, 2N×nD and nL×2N, nR×2N indicate an asymmetry split of 1:3 and 3:1. The PUs included in the CU are expressed as PU0, PU1, PU2, and PU3 sequentially.

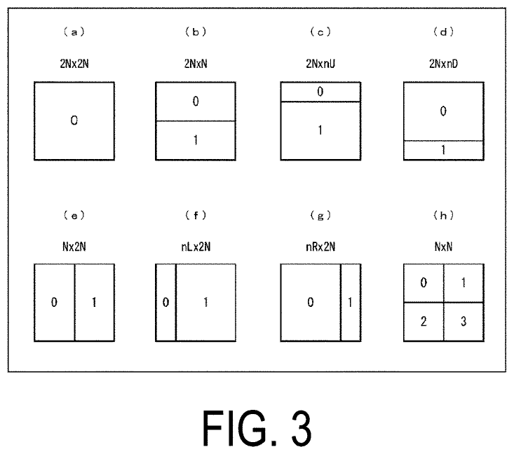

(a) to 3(h) of FIG. 3 illustrate shapes of partitions in respective PU split modes (positions of boundaries of PU splits) specifically. (a) of FIG. 3 indicates a partition of 2N×2N, and (b), (c), and (d) of FIG. 3 indicate partitions (horizontally long partitions) of 2N×N, 2N×nU, and 2N×nD, respectively. (e), (f), and (g) of FIG. 3 illustrate partitions (vertically long partitions) in cases of N×2N, nL×2N, and nR×2N, respectively, and (h) of FIG. 3 illustrates a partition of N×N. Note that horizontally long partitions and vertically long partitions are collectively referred to as rectangular partitions, and 2N×2N and N×N are collectively referred to as square partitions.

In the transform tree, the coding unit is split into one or multiple transform units, and a position and a size of each transform unit are prescribed. In another expression, the transform unit is one or multiple non-overlapping regions constituting the coding unit. The transform tree includes one or multiple transform units obtained by the above-mentioned split.

Splits in the transform tree include those to allocate a region that is the same size as the coding unit as a transform unit, and those by recursive quad tree splits similar to the above-mentioned split of CUs.

A transform processing is performed for each of these transform units.

### Prediction Parameter

A prediction image of Prediction Units (PUs) is derived by prediction parameters attached to the PUs. The prediction parameter includes a prediction parameter of an intra prediction or a prediction parameter of an inter prediction.

### Reference Picture List

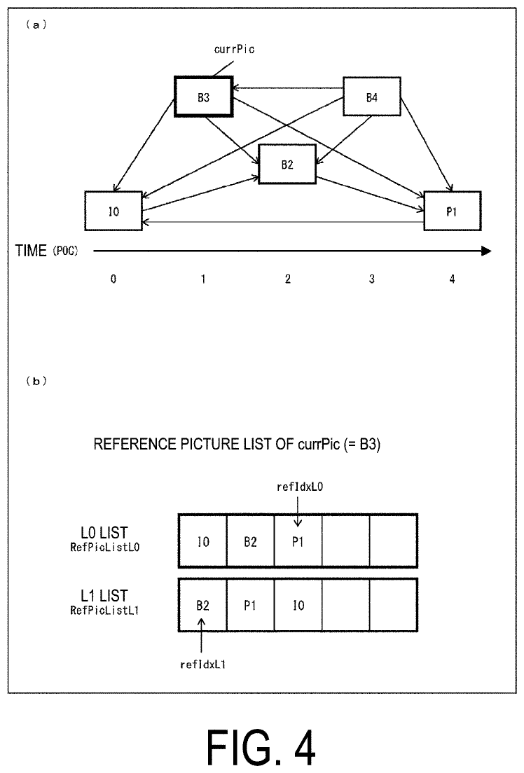

A reference picture list is a list constituted by reference pictures stored in a reference picture memory 306. FIG. 4 is a conceptual diagram illustrating an example of reference pictures and reference picture lists. In (a) of FIG. 4, a rectangle indicates a picture, an arrow indicates a reference relationship of a picture, a horizontal axis indicates time, I, P, and B in a rectangle indicate an intra-picture, a uni-prediction picture, a bi-prediction picture, respectively, and a number in a rectangle indicates a decoding order. As illustrated, the decoding order of the pictures is I0, P1, B2, B3, and B4, and the display order is I0, B3, B2, B4, and P1. (b) of FIG. 4 indicates an example of reference picture lists. The reference picture list is a list to represent a candidate of a reference picture, and one picture (slice) may include one or more reference picture lists.

### Merge Prediction and AMVP Prediction

Decoding (coding) methods of prediction parameters include a merge prediction (merge) mode and an Adaptive Motion Vector Prediction (AMVP) mode, and merge flag merge_flag is a flag to identify these. The merge mode is a mode to use to derive from prediction parameters of neighboring PUs already processed without including a prediction list utilization flag predFlagLX (or an inter prediction indicator inter_pred_idc), a reference picture index refIdxLX, and a motion vector mvLX in a coded data. The AMVP mode is a mode in which the inter prediction indicator inter_pred_idc, the reference picture index refIdxLX, and the motion vector mvLX are included in a coded data. Note that, the motion vector mvLX is coded as a prediction vector index mvp_LX_idx identifying a prediction vector mvpLX and a difference vector mvdLX.

### Motion Vector

The motion vector mvLX indicates a gap quantity between blocks in two different pictures. A prediction vector and a difference vector related to the motion vector mvLX is referred to as a prediction vector mvpLX and a difference vector mvdLX respectively.

Inter Prediction Indicator inter_pred_idc and Prediction List Utilization Flag predFlagLX

A relationship between an inter prediction indicator inter_pred_idc and prediction list utilization flags predFlagL0 and predFlagL1 are as follows, and those can be transformed mutually.

inter_pred_idc=(predFlagL1<<1)+predFlagL0

predFlagL0=inter_pred_idc & 1

predFlagL1=inter_pred_idc>>1

### Intra Prediction Mode

A luminance intra prediction mode IntraPredModeY includes 67 modes, and corresponds to a planar prediction (0), a DC prediction (1), and directional predictions (2 to 66). A chrominance intra prediction mode IntraPredModeC includes 68 modes obtained by adding a Colour Component Linear Mode (CCLM) to the 67 modes described above.

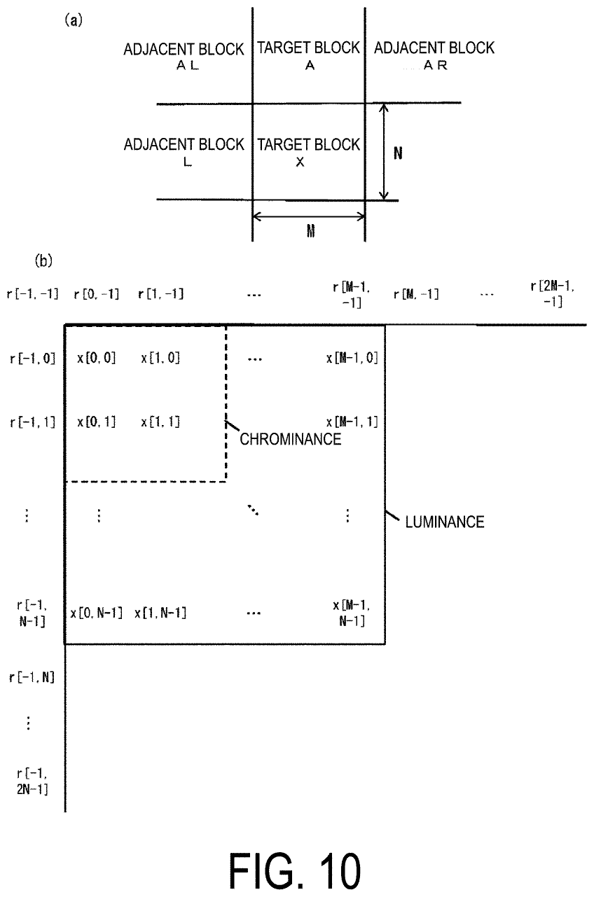

FIG. 10(a) is a diagram illustrating a target block X (the block may be the CU, the PU, or the TU) and adjacent blocks AL, A, AR, and L on an upper left side, an upper side, an upper right side, and a left side thereof. FIG. 10(b) is a diagram illustrating, in the 4:2:0 format, each pixel x[m, n] (m=0, . . . , M−1, n=0, . . . , N−1) of the target block X with M*N size, and a reference pixel r[−1, n] or r[m, −1] (m=0, . . . , 2M−1, n=−1, . . . , 2N−1) which is referred to during the intra prediction, in the adjacent block thereof. In a case of the 4:2:0 format, a luminance target block has a size of a block indicated by the outer solid line, and a chrominance target block has a size of a block indicated by the inner dashed line. Therefore, in the case of the chrominance target block, each pixel is expressed by x[m, n] (m=0, . . . , M/2−1, n=0, . . . , N/2−1), and a reference pixel is expressed by r[−1, n] or r[m, −1] (m=0, . . . , M−1, n=−1, . . . , N−1). Note that, hereinafter, the block size (M/2, N/2) of the chrominance component is expressed as (M2, N2).

A prediction pixel value of the planar prediction is calculated in accordance with the following equation.

predSamples[m,n]=((M−1−m)*r[−1,n]+(m+1)*r[M,−1]+M/2)>>log 2(M)+((N−1−n)*r[m,−1]+(n+1)*r[−1,N]+N/2)>>log 2(N) (Equation 1)

A prediction pixel value of the DC prediction is calculated in accordance with the following equation.

$$\begin{matrix}M - 1 N - 1 \\ predSamples [ m , n ] = ( Σ r [ m , - 1 ] + M \text{/} 2 ) >> log2(M ) + ( Σ r [ - 1 , n ] + N \text{/} 2 ) >> log2(N ) \\ m = 0 n = 0\end{matrix} \qquad ( Equation 2 )$$

A prediction pixel value of the directional prediction is calculated in accordance with the following equation.

predSamples[m,n]=(w*r[m+d,−1]+(W−w)*r[m+d+1,−1]+W/2)>>log 2(W) (Equation 3)

Here, d is a displacement of a pixel position based on the prediction direction, and w is a weight coefficient. For example, W is the sum of weights, and is, for example, 32, 64, or 128.

In a case that a difference between pre-deblock pixel values of pixels of the luminance component adjacent to each other through a block boundary is less than a predetermined threshold, a deblocking filter performs image smoothing in the vicinity of the block boundary by performing deblocking processing on the pixels of the luminance and chrominance components at the block boundary.

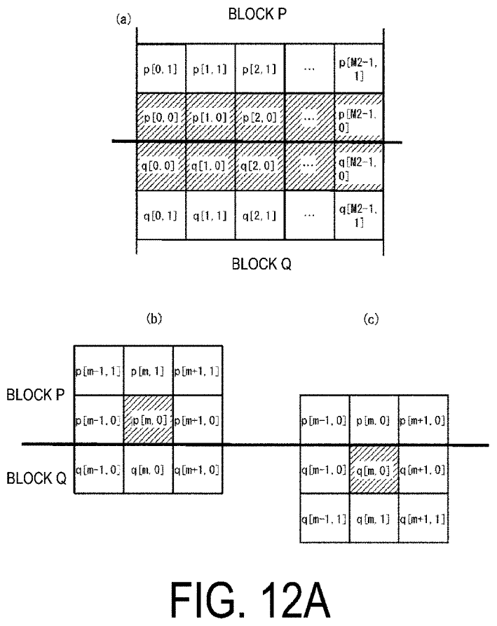

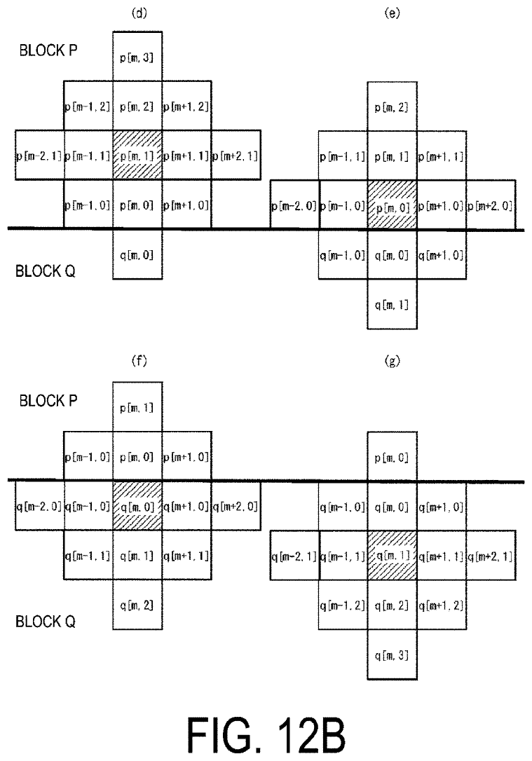

FIG. 12(a) illustrates two blocks P (pixel value p[m, n]) and Q (pixel value q[m, n]) of chrominance components horizontally bordering each other. In a case that it is determined that the deblocking filter is applied, the deblocking filter removes block distortion by referring to pixels of T pixels or less from the block boundary and correcting pixel values of the filter target pixels p[m, 0] and q[m, 0] indicated by diagonal lines in accordance with the following equation. In the following, an example of T=4 and the reference pixels being p[m, 1], p[m, 0], q[m, 0], and q[m, 1] will be described.

Δ=Clip3(−tc,tc,(((q[m,0]−p[m,0])<<2)+p[m,1]−q[m,1]+4)>>3)

p[m,0]=Clip1(p[m,0]+Δ)

q[m,0]=Clip1(q[m,0]−Δ) (Equation 4)

Here, tc represents a predetermined threshold, Clip1(x) represents 0<=x<=the maximum value of chrominance.

An SAO is a filter that is mainly applied after the deblocking filter, and has an effect of removing ringing distortion and quantization distortion. The SAO is a process in units of CTUs, and is a filter that classifies the pixel values into several categories to add/subtract an offset in units of pixels for each category. In edge offset (EO) processing of the SAO, an offset value that is added to the pixel value is determined in accordance with a magnitude relationship between the target pixel value and the adjacent pixel (reference pixel) value.

FIG. 12(b) illustrates two blocks P (pixel value p[m, n]) and Q (pixel value q[m, n]) of chrominance components horizontally bordering each other. In the EO processing, by referring to a pixel signaled with the coded data among (p[m, 1], q[m, 0]), (p[m−1, 0], p[m+1, 0]), (p[m−1, 1], q[m+1, 0]), and (p[m+1, 1], q[m−1, 0]) adjacent to the EO target pixel p[m, 0] indicated by diagonal lines in a vertical direction, a horizontal direction, an upper left-lower right diagonal direction, and an upper right-lower left diagonal direction, respectively, selecting an offset offsetP, and adding/subtracting the offset to/from p[m, 0], the ringing and the quantization distortion are removed. In the same manner, in FIG. 12(c), by referring to a pixel signaled with the coded data among (p[m, 0], q[m, 1]), (q[m−1, 0], q[m+1, 0]), (p[m−1, 0], q[m+1, 1]), and (p[m+1, 0], q[m−1, 1]) adjacent to the EO target pixel q[m, 0] indicated by diagonal lines in the vertical direction, the horizontal direction, the upper left-lower right diagonal direction, and the upper right-lower left diagonal direction, respectively, selecting an offset offsetQ, and adding/subtracting the offset to/from q[m, 0], the ringing and the quantization distortion are removed.

p[m,0]=p[m,0]+offsetP

q[m,0]=q[m,0]+offset (Equation 5)

In an ALF, by applying adaptive filter processing to a decoded image before the ALF using an ALF parameter ALFP decoded from the coded data Te, an ALF-processed decoded image is generated.

FIGS. 12(d) to 12(g) are diagrams illustrating the ALF processing in two blocks P (pixel value p[m, n]) and Q (pixel value q[m, n]) of chrominance components horizontally bordering each other. In the ALF, by applying a filter of S×S taps with a diamond shape to ALF target pixels p[m, 1], p[m, 0], q[m, 0], and q[m, 1] indicated by diagonal lines, image quality is improved. Hereinafter, a case of S=5 will be described. In other words, reference is made to the adjacent pixels for five lines illustrated in FIGS. 12(d) to 12(g).

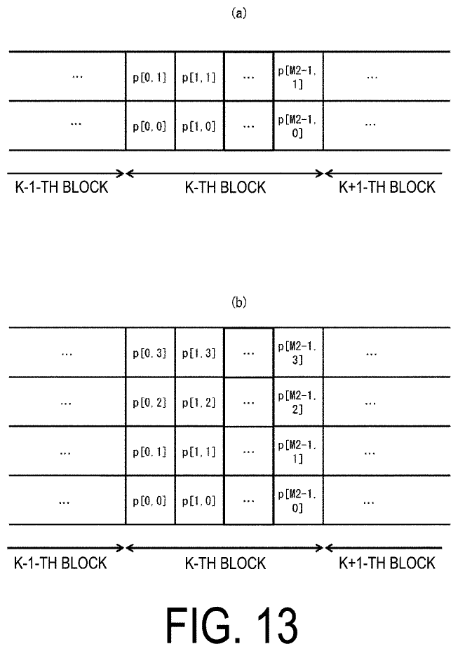

FIG. 13 is a diagram illustrating a memory for storing reference pixels to be referred to by a loop filter. FIG. 13(a) is a memory for storing the reference pixels of the chrominance component of the deblocking filter and the SAO (EO), and FIG. 13(b) is a memory for storing reference pixels of the chrominance component in a case that the ALF is added. These are line memories in which decoded pixels of the block that is decoded one block row before the target block are stored. In a case of the 4:2:0 format, this memory stores reference pixels of the chrominance component for the number of width pixels/2*the number of lines of an image with width*height size. For example, in the 4K (3840*2160) image, for the reference pixels of the chrominance component of the deblocking filter and the SAO (EO), the reference pixels for two lines are stored as illustrated in FIG. 13(a), and thus the Cb and Cr components of 1920 pixels*2 for each are stored. Furthermore, in a case that ALF processing is performed, the reference pixels for four lines are stored as illustrated in FIG. 13(b), and thus the Cb and Cr components of 1920 pixels*4 for each are stored.

### Configuration of Image Decoding Apparatus

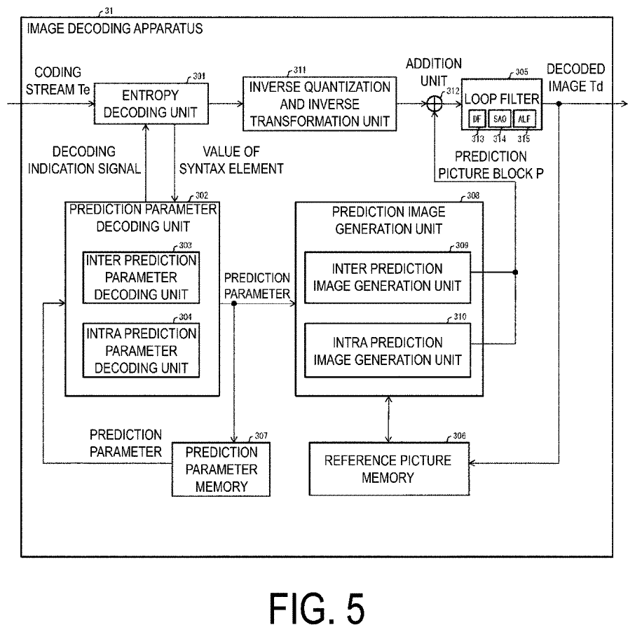

A configuration of the image decoding apparatus 31 according to the present embodiment will now be described. FIG. 5 is a schematic diagram illustrating a configuration of the image decoding apparatus 31 according to the present embodiment. The image decoding apparatus 31 includes an entropy decoding unit 301, a prediction parameter decoding unit (a prediction image decoding apparatus) 302, a loop filter 305, a reference picture memory 306, a prediction parameter memory 307, a prediction image generation unit (prediction image generation apparatus) 308, an inverse quantization and inverse transformation unit 311, and an addition unit 312. Note that in accordance with the image coding apparatus 11, there is also a configuration in which the loop filter 305 is not included in the image decoding apparatus 31.

The prediction parameter decoding unit 302 includes an inter prediction parameter decoding unit 303 and an intra prediction parameter decoding unit 304. The prediction image generation unit 308 includes an inter prediction image generation unit 309 and an intra prediction image generation unit 310.

The entropy decoding unit 301 performs entropy decoding on the coding stream Te input from the outside, and separates and decodes individual codes (syntax elements). Separated codes include a prediction parameter to generate a prediction image, residual information to generate a difference image, and the like.

The entropy decoding unit 301 outputs a part of the separated codes to the prediction parameter decoding unit 302. For example, a part of the separated codes includes a prediction mode predMode, a PU split mode part_mode, a merge flag merge_flag, a merge index merge_idx, an inter prediction indicator inter_pred_idc, a reference picture index ref_Idx_1X, a prediction vector index mvp_LX_idx, and a difference vector mvdLX. The control of which code to decode is performed based on an indication of the prediction parameter decoding unit 302. The entropy decoding unit 301 outputs quantization coefficients to the inverse quantization and inverse transformation unit 311. These quantization coefficients are coefficients obtained by performing frequency transform, such as Discrete Cosine Transform (DCT), Discrete Sine Transform (DST), Karyhnen Loeve Transform (KLT), or the like, on residual signal to quantize in coding processing.

The inter prediction parameter decoding unit 303 decodes an inter prediction parameter with reference to a prediction parameter stored in the prediction parameter memory 307, based on a code input from the entropy decoding unit 301.

The inter prediction parameter decoding unit 303 outputs a decoded inter prediction parameter to the prediction image generation unit 308, and also stores the decoded inter prediction parameter in the prediction parameter memory 307.

The intra prediction parameter decoding unit 304 decodes an intra prediction parameter with reference to a prediction parameter stored in the prediction parameter memory 307, based on a code input from the entropy decoding unit 301. The intra prediction parameter is a parameter used in a processing to predict a CU in one picture, for example, an intra prediction mode IntraPredMode. The intra prediction parameter decoding unit 304 outputs a decoded intra prediction parameter to the prediction image generation unit 308, and also stores the decoded intra prediction parameter in the prediction parameter memory 307.

The loop filter 305 applies a filter such as a deblocking filter 313, a sample adaptive offset (SAO) 314, and an adaptive loop filter (ALF) 315 on a decoded image of a CU generated by the addition unit 312. Note that as long as the loop filter 305 is paired with the image coding apparatus, the above-described three types of filters are not necessarily included, and a configuration including only the deblocking filter 313 may be employed, for example.

The reference picture memory 306 stores a decoded image of a CU generated by the addition unit 312 in a prescribed position for each picture and CU of a decoding target.

The prediction parameter memory 307 stores a prediction parameter in a prescribed position for each picture and prediction unit (or a subblock, a fixed size block, and a pixel) of a decoding target. Specifically, the prediction parameter memory 307 stores an inter prediction parameter decoded by the inter prediction parameter decoding unit 303, an intra prediction parameter decoded by the intra prediction parameter decoding unit 304 and a prediction mode predMode separated by the entropy decoding unit 301. For example, inter prediction parameters stored include a prediction list utilization flag predFlagLX (the inter prediction indicator inter_pred_idc), a reference picture index refIdxLX, and a motion vector mvLX.

To the prediction image generation unit 308, a prediction mode predMode input from the entropy decoding unit 301 is input, and a prediction parameter is input from the prediction parameter decoding unit 302. The prediction image generation unit 308 reads a reference picture from the reference picture memory 306. The prediction image generation unit 308 generates a prediction image of a PU or a subblock by using a prediction parameter that is input and a reference picture (reference picture block) that is read, with a prediction mode indicated by the prediction mode predMode.

Here, in a case that the prediction mode predMode indicates an inter prediction mode, the inter prediction image generation unit 309 generates a prediction image of a PU or a subblock by an inter prediction by using an inter prediction parameter input from the inter prediction parameter decoding unit 303 and a reference picture (reference picture block) that is read.

For a reference picture list (an L0 list or an L1 list) where a prediction list utilization flag predFlagLX is 1, the inter prediction image generation unit 309 reads a reference picture block from the reference picture memory 306 in a position indicated by a motion vector mvLX, based on a decoding target PU from reference pictures indicated by the reference picture index refIdxLX. The inter prediction image generation unit 309 performs a prediction based on a read reference picture block and generates a prediction image of a PU. The inter prediction image generation unit 309 outputs the generated prediction image of the PU to the addition unit 312. Here, the reference picture block refers to a collection of pixels (referred to as a block because it is normally rectangular) on a reference picture, and is a region that is referred to in order to generate a prediction image of the PU or the subblock.

In a case that the prediction mode predMode indicates an intra prediction mode, the intra prediction image generation unit 310 performs an intra prediction by using an intra prediction parameter input from the intra prediction parameter decoding unit 304 and a read reference picture. Specifically, the intra prediction image generation unit 310 reads an adjacent block, which is a picture of a decoding target, in a prescribed range from a decoding target block among blocks (PUs) already decoded, from the reference picture memory 306 (frame memory, reference memory) to an internal memory (internal reference memory).

The reference picture memory 306 may be separated into a frame memory for holding a decoded image, a memory for holding only a partial image for the intra prediction or the loop filter (column memory, line memory), and a memory for holding a partial image inside the CTU block. Hereinafter, a case of being described as a reference memory refers primarily to a case of memory that holds only a partial image for the intra prediction or the loop filter.

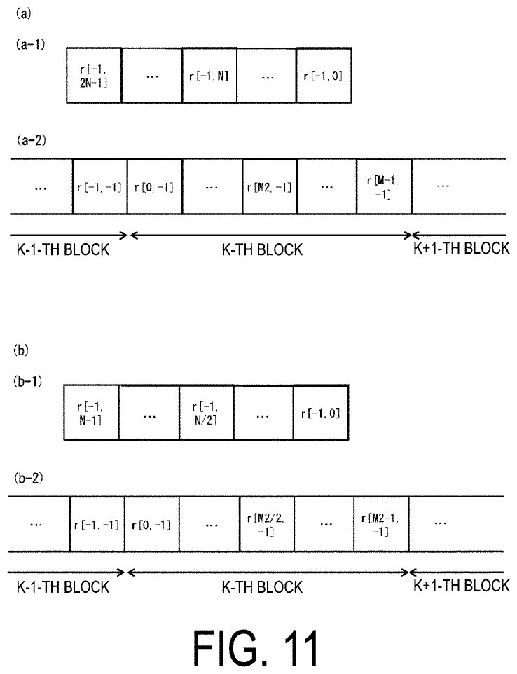

FIG. 11 is a diagram illustrating a reference memory (column memory, line memory) for storing reference pixels referred to in the intra prediction for a prediction of subsequent blocks. FIG. 11(a) is a reference memory for storing reference pixels of the luminance component and FIG. 11(b) is a reference memory for storing reference pixels of the chrominance component, in the 4:2:0 format-compliant image decoding apparatus. In FIG. 11(a), (a−1) is a memory that stores reference pixels r[−1, −1] to r[−1, 2N−1] on the left side, and (a−2) is a memory that stores reference pixels r[0, −1] to r[M−1, −1] on the upper side, of the luminance target block. (b−1) is a memory that stores reference pixels r[−1, −1] to r[−1, N−1] on the left side, and (b−2) is a memory that stores reference pixels r[0, −1] to r[M2−1, −1] on the upper side, of the chrominance target block. Each of the memories (a−1) and (b−1) for storing the reference pixels on the left side of the target block is a column memory that stores decoded pixels of the block that is decoded latest and that is updated every time the processing of the block ends. Each of the memories (a−2) and (b−2) for storing reference pixels on the upper side of the target block is a line memory that stores decoded pixels of the block that is decoded one block row before. The column memory may hold multiple columns, and the line memory may hold multiple lines. For example, in an image with width*height size, the line memory of the reference memory stores reference pixels, for the number of width pixels*the number of lines for the luminance component, and for the number of width/2 pixels*the number of lines for the chrominance component. For example, in the 4K (3840*2160) image, in a case of the 4:2:0 format in which reference pixels for one line is stored, the luminance component of 3840 pixels and Cb and Cr components of the chrominance components of 1920 pixels for each are stored.

Note that in the example illustrated in the drawings, a case has been described in which the block size to be processed is fixed, but a configuration of a variable block size or a recursive tree split (quad tree or binary tree) may be employed. For example, in a case that the CTU block is recursively split, the reference memory includes a CTU internal reference memory that includes the target block and a CTU external reference memory for reference across the CTU boundary. Reference is made to the CTU internal memory in a case that the adjacent image to which the target block refers is in the CTU block, and reference is made to the CTU external reference memory in a case that the adjacent image to which the target block refers is not in the CTU block. The CTU external reference memory uses a column memory that stores decoded pixels of the CTU block that is decoded latest and that is updated every time the processing of the block ends, a line memory that stores decoded pixels of the block that is decoded one CTU block row before.

The internal memory is preferably a memory that can be accessed at high speed, and is used by copying contents of the reference picture memory. The prescribed range is, for example, any of left, upper left, upper, and upper right adjacent blocks in a case that a decoding target block moves in order so-called raster scan sequentially, and varies according to the intra prediction mode. The order of the raster scan is an order to move sequentially from the left edge to the right edge in each picture for each row from the top edge to the bottom edge.

The intra prediction image generation unit 310 performs a prediction in a prediction mode indicated by the intra prediction mode IntraPredMode for a read adjacent block, and generates a prediction image of a block. The intra prediction image generation unit 310 outputs the generated prediction image of the block to the addition unit 312.

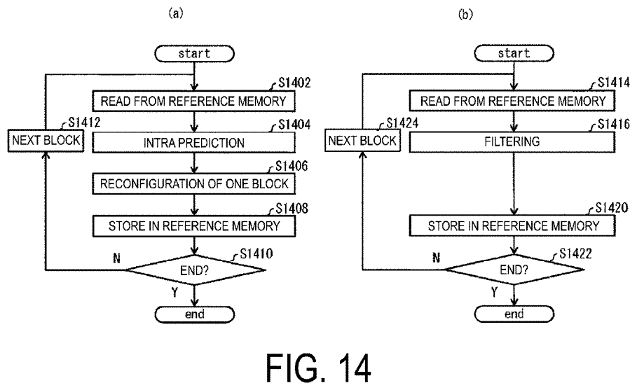

FIG. 14(a) is a flow chart illustrating access to the reference pixels stored in the reference memory in the intra prediction. The intra prediction image generation unit 310 reads reference pixels required for prediction of the target block from the reference memory, and stores the read pixels in an internal memory (not illustrated) of the intra prediction image generation unit 310 (S1402). The intra prediction image generation unit 310 performs the intra prediction using the reference pixels stored in the internal memory (S1404). After reconstruction processing (S1406) of the target block has ended, the image decoding apparatus 31 stores the lowermost line of the target block in the reference memory (S1408). The image decoding apparatus 31 checks whether the target block is the last block of a picture (S1410), in a case that it is not the last block (N in S1410), the process proceeds to the next block process (S1412), and processes from S1402 are repeated. In a case of the last block (Y in S1410), the process ends. The access to the reference memory is common processing to the image coding apparatus 11 and the image decoding apparatus 31, and in description of the image coding apparatus 11 described later, it is sufficient that the image decoding apparatus 31 described above is replaced by the image coding apparatus 11 and the reconstruction processing is replaced by reconstruction processing during local decoding, and thus the description will be omitted.

The inverse quantization and inverse transformation unit 311 performs inverse quantization on a quantized transform coefficient input from the entropy decoding unit 301, performs inverse frequency transform such as inverse DST, inverse KLT, or the like, and calculates a prediction residual signal. The inverse quantization and inverse transformation unit 311 outputs the calculated residual signal to the addition unit 312.

The addition unit 312 adds a prediction image of a block input from the inter prediction image generation unit 309 or the intra prediction image generation unit 310 and the residual signal input from the inverse quantization and inverse transformation unit 311 for each pixel, and generates a decoded image of the block. The addition unit 312 outputs the generated decoded image of the block to at least any one of the deblocking filter 313, the SAO (sample adaptive offset) unit 314, or the ALF 315.

The deblocking filter 313 performs deblocking processing on the decoded image of the block, which is the output of the addition unit, and outputs the result as a deblocked decoded image.

The SAO unit 314 performs offset filter processing on the output image of the addition unit 312 or the deblocked decoded image output from the deblocking filter 313, using the offset decoded from the coded data Te, and outputs the result as a SAO-processed decoded image.

The ALF 315 performs adaptive filter processing on the output image of the addition unit 312, the deblocked decoded image, or the SAO-processed decoded image, using an ALF parameter ALFP decoded from the coded data Te, and generates an ALF-processed decoded image. The ALF-processed decoded image is output to the outside as a decoded image Td, and is stored in the reference picture memory 306 in association with POC information decoded from the coded data Te by the entropy decoding unit 301.

FIG. 14(b) is a flow chart illustrating access to the reference pixels stored in the reference memory with the loop filter. The loop filter 305 reads the reference pixels required for prediction of the target block from the reference memory, and stores the read pixels in an internal memory (not illustrated) of the loop filter 305 (S1414). The loop filter 305 performs loop filter processing of the deblocking filter, the SAO, the ALF, or the like, using the reference pixels stored in the internal memory (S1416). After the loop filter processing has ended, the image decoding apparatus 31 (or the loop filter 305) stores the predetermined number of lines from the first line of the target block, in the reference memory (S1420). The image decoding apparatus 31 checks whether the target block is the last block of a picture (S1422), in a case that it is not the last block (N in S1422), the process proceeds to the next block process (S1424), and processes from S1414 are repeated. In a case of the last block (Y in S1422), the process ends. The access to the reference memory is common processing to the image coding apparatus 11 and the image decoding apparatus 31, and in description of the image coding apparatus 11 described later, it is sufficient that the image decoding apparatus 31 described above is replaced by the image coding apparatus 11 and the loop filter 305 is replaced by the loop filter 107, and thus the description will be omitted.

### Configuration of Image Coding Apparatus

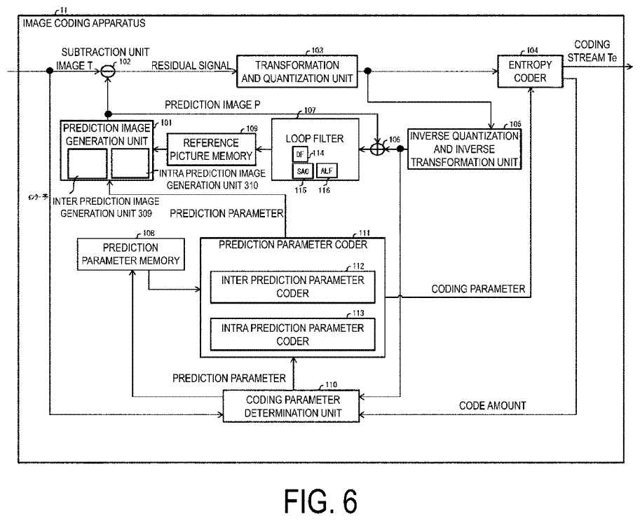

A configuration of the image coding apparatus 11 according to the present embodiment will now be described. FIG. 6 is a block diagram illustrating a configuration of the image coding apparatus 11 according to the present embodiment. The image coding apparatus 11 is configured to include a prediction image generation unit 101, a subtraction unit 102, a transformation and quantization unit 103, an entropy coder 104, an inverse quantization and inverse transformation unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, and a prediction parameter coder 111. The prediction parameter coder 111 is configured to include an inter prediction parameter coder 112 and an intra prediction parameter coder 113. Note that the image coding apparatus 11 may be configured not to include the loop filter 107.

For each picture of an image T, the prediction image generation unit 101 generates a prediction image P of a prediction unit PU for each coding unit CU that is a region where the picture is split. Here, the prediction image generation unit 101 reads a block that has been decoded from the reference picture memory 109, based on a prediction parameter input from the prediction parameter coder 111. For example, in a case of an inter prediction, the prediction parameter input from the prediction parameter coder 111 is a motion vector. The prediction image generation unit 101 reads a block in a position in a reference image indicated by a motion vector starting from a target PU. In a case of an intra prediction, the prediction parameter is, for example, an intra prediction mode. A pixel value of an adjacent block (PU) used in the intra prediction mode is read from the reference picture memory 109, and the prediction image P of the block is generated. The prediction image generation unit 101 generates the prediction image P of the block by using one prediction scheme among multiple prediction schemes for the read reference picture block. The prediction image generation unit 101 outputs the generated prediction image P of the block to the subtraction unit 102.

Note that in the same manner as the prediction image generation unit 308 described above, since the prediction image generation unit 101 includes the inter prediction image generation unit 309 and the intra prediction image generation unit 310 and the same operation is performed, the description thereof is omitted.

The prediction image generation unit 101 generates the prediction image P of a PU (block), based on a pixel value of a reference block read from the reference picture memory, by using a parameter input by the prediction parameter coder. The prediction image generated by the prediction image generation unit 101 is output to the subtraction unit 102 and the addition unit 106.

The subtraction unit 102 subtracts a signal value of the prediction image P of a PU input from the prediction image generation unit 101 from a pixel value of a corresponding PU of the image T, and generates a residual signal. The subtraction unit 102 outputs the generated residual signal to the transformation and quantization unit 103.

The transformation and quantization unit 103 performs frequency transform on the prediction residual signal input from the subtraction unit 102, and quantizes the calculated transform coefficient to obtain a quantization coefficient. The transformation and quantization unit 103 outputs the calculated quantization coefficients to the entropy coder 104 and the inverse quantization and inverse transformation unit 105.

To the entropy coder 104, the quantization coefficient is input from the transformation and quantization unit 103, and a prediction parameter is input from the prediction parameter coder 111. For example, the input prediction parameters include codes such as a reference picture index ref_Idx_1X, a prediction vector index mvp_LX_idx, a difference vector mvdLX, a prediction mode pred_mode_flag, and a merge index merge_idx.

The entropy coder 104 performs entropy coding on the input split information, prediction parameter, quantized transform coefficient, and the like to generate the coding stream Te, and outputs the generated coding stream Te to the outside.

The inverse quantization and inverse transformation unit 105 is the same as the inverse quantization and inverse transformation unit 311 (FIG. 5) in the image decoding apparatus, and performs inverse quantization on the quantization coefficient input from the transformation and quantization unit 103 to obtain the transform coefficient. The inverse quantization and inverse transformation unit 105 performs inverse transformation on the obtained transform coefficient to calculate a residual signal. The inverse quantization and inverse transformation unit 105 outputs the calculated residual signal to the addition unit 106.

The addition unit 106 adds signal values of the prediction image P of the PUs (blocks) input from the prediction image generation unit 101 and signal values of the residual signals input from the inverse quantization and inverse transformation unit 105 for each pixel, and generates the decoded image. The addition unit 106 stores the generated decoded image in the reference picture memory 109.

The loop filter 107 applies a deblocking filter 114, a sample adaptive offset (SAO) 115, and an adaptive loop filter (ALF) 116 to the decoded image generated by the addition unit 106. Note that the loop filter 107 does not necessarily include the above-described three types of filters and a configuration including only the deblocking filter 114 may be employed, for example.

The prediction parameter memory 108 stores the prediction parameters generated by the coding parameter determination unit 110 for each picture and CU of the coding target in a prescribed position.

The reference picture memory 109 stores the decoded image generated by the loop filter 107 for each picture and CU of the coding target in a prescribed position.

The coding parameter determination unit 110 selects one set among multiple sets of coding parameters. A coding parameter is the above-mentioned QTBT split parameter, the prediction parameter, or the parameter to be a target of coding generated associated with the parameters. The prediction image generation unit 101 generates the prediction image P of the PUs by using each of the sets of these coding parameters.

The coding parameter determination unit 110 calculates an RD cost value indicating a volume of an information quantity and coding errors for each of the multiple sets. For example, the RD cost value is the sum of a code amount and a value obtained by multiplying a square error by a coefficient λ. The code amount is an information quantity of the coding stream Te obtained by performing entropy coding on a quantization residual and a coding parameter. The square error is a sum of pixels for square values of residual values of residual signals calculated in the subtraction unit 102. The coefficient X is a real number that is larger than a pre-configured zero. The coding parameter determination unit 110 selects a set of coding parameters by which the calculated RD cost value is minimized. With this configuration, the entropy coder 104 outputs the selected set of coding parameters as the coding stream Te to the outside, and does not output sets of coding parameters that are not selected. The coding parameter determination unit 110 stores the determined coding parameters in the prediction parameter memory 108.

The prediction parameter coder 111 derives a format for coding from parameters input from the coding parameter determination unit 110, and outputs the format to the entropy coder 104. A derivation of a format for coding is, for example, to derive a difference vector from a motion vector and a prediction vector. The prediction parameter coder 111 derives parameters necessary to generate a prediction image from parameters input from the coding parameter determination unit 110, and outputs the parameters to the prediction image generation unit 101. For example, parameters necessary to generate a prediction image are a motion vector of a subblock unit.

The inter prediction parameter coder 112 derives inter prediction parameters such as a difference vector, based on prediction parameters input from the coding parameter determination unit 110. The inter prediction parameter coder 112 includes a partly identical configuration to a configuration by which the inter prediction parameter decoding unit 303 derives inter prediction parameters, as a configuration to derive parameters necessary for generation of a prediction image output to the prediction image generation unit 101. The intra prediction parameter coder 113 includes a partly identical configuration to a configuration by which the intra prediction parameter decoding unit 304 derives intra prediction parameters, as a configuration to derive prediction parameters necessary for generation of a prediction image output to the prediction image generation unit 101.

The intra prediction parameter coder 113 derives a format for coding (for example, MPM_idx, rem_intra_luma_pred_mode, and the like) from the intra prediction mode IntraPredMode input from the coding parameter determination unit 110.

As described above, the memory required by each of the 4:4:4 format and the 4:2:0 format is the same for the luminance component, but for the chrominance component, the 4:4:4 format requires memory twice that of the 4:2:0 format in each of the vertical and horizontal directions. In particular, as illustrated in FIG. 11, it is sufficient that the memory (column) for storing the reference pixels on the left side of the target block holds those for a 1 CTU height, and thus even in a case that the CTU height of the chrominance pixel is doubled by using the 4:4:4 format, there may not be a significant problem. However, the line memory that stores the reference pixels on the upper side of the target block requires a size proportional to the width of the image, and therefore has a large effect on cost. For example, in an 4K image, in a case of storing one line, for each of the Cb and Cr, memory for 1920 pixels is required in the 4:2:0 format, but memory for 3840 pixels is required in the 4:4:4 format. In a case of storing two lines, for each of the Cb and Cr, memory for 3840 pixels is required in the 4:2:0 format, but memory for 7680 pixels is required in the 4:4:4 format. In a case of storing four lines, for each of the Cb and Cr, memory for 7680 pixels is required in the 4:2:0 format, but memory for 15360 pixels is required in the 4:4:4 format. In a case of the image size of 8K, memory twice the above description is required for each case. This increase in the line memory size has a significant influence on the design of the image decoding apparatus.

The following describes techniques to enable processing of the 4:4:4 format in a line memory with size required by the 4:2:0 format.

### Intra Prediction

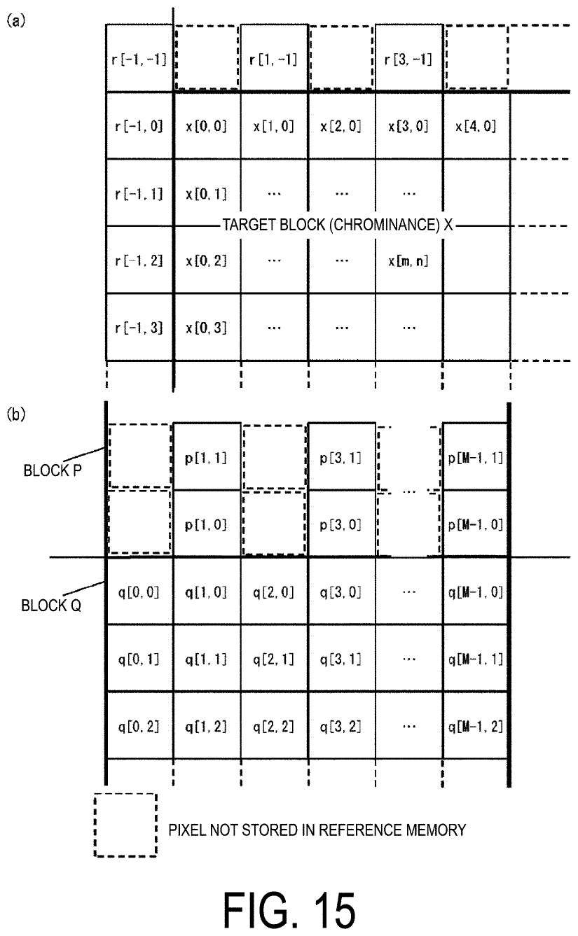

FIG. 15(a) illustrates an example of a case of referring to reference pixels of the chrominance component from the reference memory in the image decoding apparatus of the present specification, in a case of performing the intra prediction on the coded data in the 4:4:4 format. Since the coded data are in the 4:4:4 format, the target block X (pixels x[m, n], m=0, . . . , M−1, n=0, . . . , N−1) of the chrominance component has pixels of the same size (M*N) as the luminance component. The reference pixels on the left side of the target block are r[−1, n] and the reference pixels on the upper side are r[m, −1](m=0, . . . , 2M−1, n=−1, . . . , 2N−1). In one configuration example of the image decoding apparatus of the present specification that is capable of decoding with the line memory for the 4:2:0 format, reference is made to only half pixels from the reference memory (line memory) that stores the reference pixels on the upper side of the target block. That is, as illustrated in FIG. 15(a), on the upper side of the target block, reference to the reference pixels at even-numbered positions r[2m, −1] from the line memory is not made. These reference pixels are indispensable for calculating the intra prediction value using (Equation 1) to (Equation 3), and are therefore derived from reference pixels by the method described later.

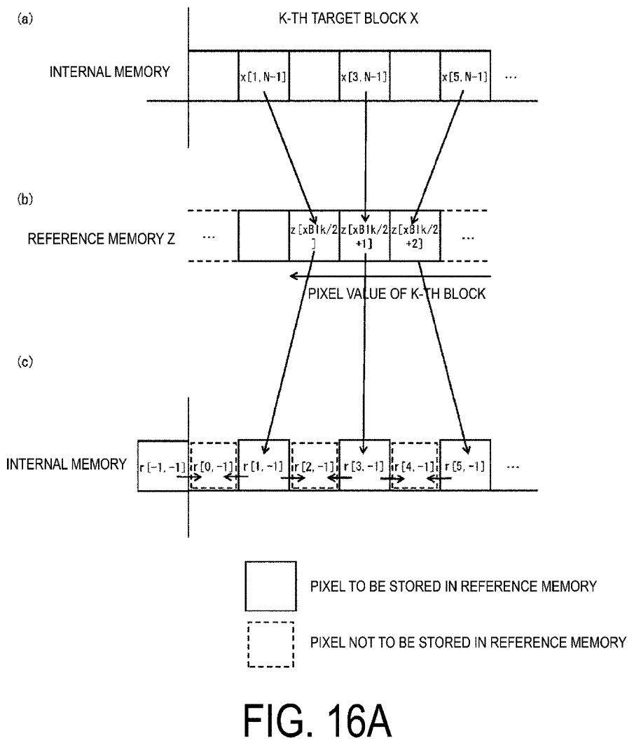

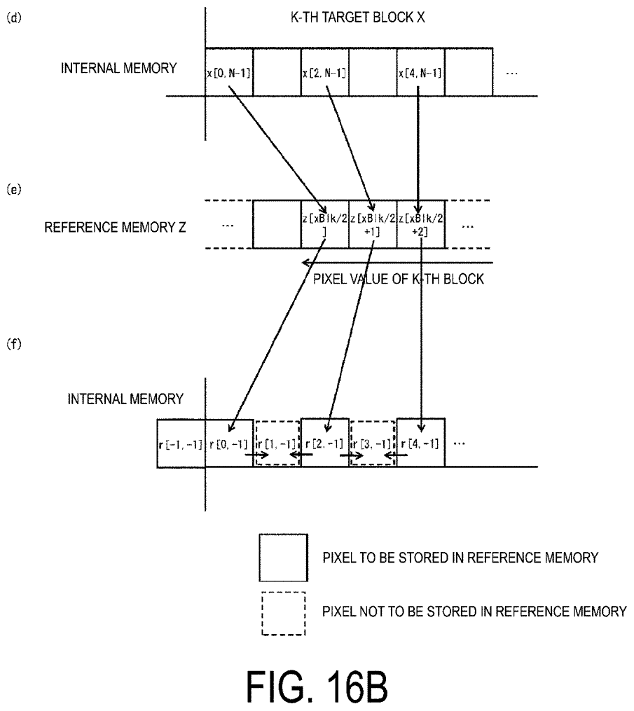

In an example of the image coding apparatus and the image decoding apparatus according to Embodiment 1, in the case of the chrominance component of an image of the 4:4:4 format, as illustrated in FIG. 16(a), at the time of storing the decoded pixel values x[m, N−1] in the reference memory, only the odd-numbered decoded pixels x[2 m+1, N−1] in the lowermost line of the target block are stored. In a case of reading the reference memory to decode the target block one block line below, reference is made to the odd-numbered position [2 m+1]. The reference pixel r[2m, −1] at the even-numbered position is interpolated using the read reference pixel r[2 m+1, −1] at the odd-numbered position. The reference pixel r[2 m+1, −1] read from the reference memory, r[2m, −1] that is obtained by the interpolation, and the reference pixel r[−1, n] on the left side of the target block are substituted into (Equation 1) to (Equation 3) to calculate the intra prediction value. In the following, description will be given using two types of reference memories of a two-dimensional array refImg[,] and one-dimensional array z[ ]. In the same manner as the image decoding apparatus, since the image coding apparatus stores only pixels at odd-numbered positions, interpolates pixels at even-numbered positions from pixels at odd-numbered positions, and performs the intra prediction using both pixels, no mismatch occurs between the image coding apparatus and the image decoding apparatus.

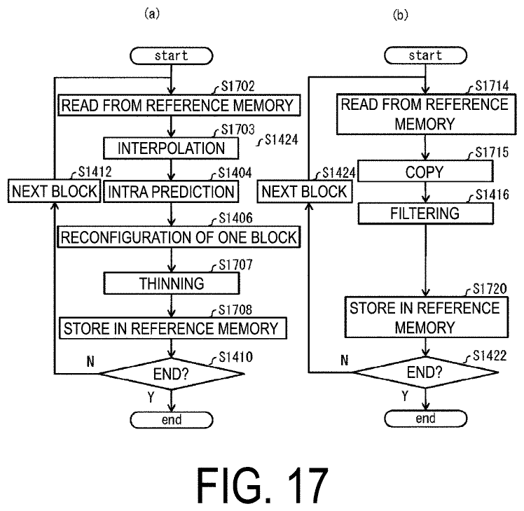

FIG. 17(a) is a flowchart illustrating operations described above. In the flowchart, S1404, S1406, S1410, and S1412 are the same operations as those in FIG. 14(a), and description thereof is omitted. The intra prediction image generation unit 310 reads the reference pixels required for prediction of the target block from the reference memory, and stores the read pixels in odd-numbered positions r[2 m+1, −1] (m=0, . . . , M2−1) in an internal memory (not illustrated) of the intra prediction image generation unit 310 (S1602).

r[2m+1,−1]=refImg[xBlk+2m−1,yBlk−1](m=0, . . . ,M2−1)

Here, xBlk and yBlk are an upper left coordinate of the target block. Note that the reference memory refImg is an array having memory only in odd-numbered positions. In a case that a continuous array z[ ] is used, as illustrated in FIG. 16(b), reference as described below is made.

r[2m+1,−1]=z[xBlk/2+m](m=0, . . . ,M2−1)

Here, in a case that the block has a fixed block size M, by using an address k of the block, derivation as xBlk=M2*k*2 can be made.

The intra prediction image generation unit 310 interpolates the reference pixels at the even-numbered positions using the reference pixels at the odd-numbered positions of the internal memory (S1603). For example, an average value can be used as an interpolation method.

r[2m,−1]=(r[2m+1,−1]+r[2m−1,−1]+1)>>1

The intra prediction is performed using the reference pixels read from the reference memory and the reference pixels generated by the interpolation (S1404). After the reconstruction processing (S1406) of the target block has ended, the image coding apparatus 11 or the image decoding apparatus 31 stores odd-numbered decoded pixels (x[2 m+1, N−1] in FIG. 16(a)) of the lowermost line of the target block in the reference memory refImg or Z (S1608).

refImg[xBlk+2m−1,yBlk+N−1]=x[2m+1,N−1]

In a case that the continuous array z[ ] is used, as illustrated in FIG. 16(b), storing as described below is performed.

z[xBlk/2+m]=x[2m+1,N−1]

Furthermore, as illustrated in FIGS. 16(d) to 16(f), at the time of storing the decoded pixel values x[m, N−1] of the internal memory in the reference memory, only the even-numbered decoded pixels in the lowermost line of the target block may be stored. In a case of reading the reference pixels from the reference memory refImg or Z to decode the block one block line below, reference is made to the even-numbered position [2m, −1] and the reference pixels r[2 m+1, −1] at the odd-numbered positions may be interpolated. In this case, in the above description of the flowchart, the odd-numbered pixel and the even-numbered pixel may be replaced.

As described above, as the reference pixels for the intra prediction, by storing the pixels of half the number of pixels in the horizontal direction, and generating the remaining half of the pixels by the interpolation, it is possible to regenerate the coded data of the 4:4:4 format by the image decoding apparatus having the reference memory for decoding the coded data of the 4:2:0 format as the line memory. Note that in the present embodiment, there is no effect of reducing the column memory and the frame memory of the reference memory, but the size of the column memory is small and the frame memory is inexpensive, which is not particularly problematic.

### Modification 1

In Embodiment 1, after (local) decoding, pixels at the odd-numbered positions or even-numbered positions of the lowermost line of the block of the chrominance component were stored in the reference memory. In Modification 1, an example of storing the chrominance component at a position different from that of Embodiment 1 in the reference memory will be described.

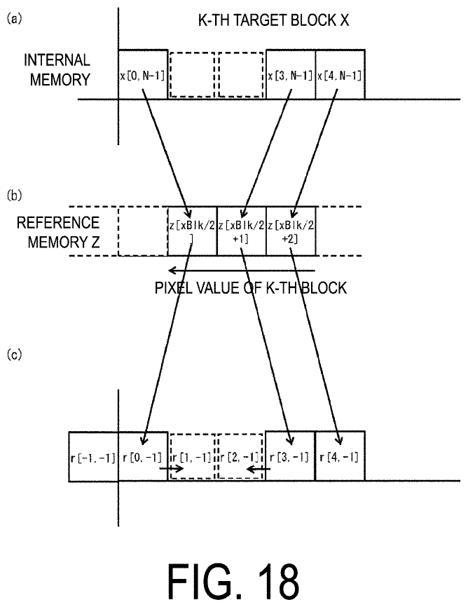

In Modification 1, at the time of storing the decoded pixel values x[m, N−1] of the internal memory in the reference memory, only the decoded pixels x[4m, N−1] and x[4 m+3, N−1] at positions illustrated in FIG. 18(a) in the lowermost line of the target block are stored.

refImg[xBlk+4m,yBlk+N−1]=x[4m,N−1]

refImg[xBlk+4m+3,yBlk+N−1]=x[4m+3,N−1]

In a case that the continuous array z[ ] is used, as illustrated in FIG. 18(b), storing as described below is performed.

z[xBlk/2+m]=x[4m,N−1]

z[xBlk/2+m+1]=x[4m+3,N−1]

In a case of reading the reference pixels from the reference memory refImg to decode the block one block line below, the pixels are stored in the positions [4m, −1] and [4 m+3, −1] of the internal memory.

r[4m,−1]=refImg[xBlk+4m,yBlk−1](m=0, . . . ,M2/2−1)

r[4m+3,−1]=refImg[xBlk+4m+3,yBlk−1](m=0, . . . ,M2/2−1)

In a case that the continuous array z[ ] is used, as illustrated in FIG. 18(c), storing as described below is performed.

r[4m,−1]=z[xBlk/2+m]

r[4m+3,−1]=z[xBlk/2+m+1]

Next, using the reference pixels r[4m, −1] and r[4 m+3, −1], the pixels r[4 m+1, −1] and r[4 m+2, −1] are interpolated.

r[4m+1,−1]=r[4m,−1]

r[4m+2,−1]=r[4m+3,−1]

In a case that the pixel positions to be stored are selected in this manner, there is an advantage in that the connection with the reference pixel r[−1, −1] of the left side block may be regular. In addition, in a case of a block with a four-pixel width, since the boundary pixel of the block is included, pixel value information, which most represents the nature of the block, can be obtained.

### Modification 2

In Embodiment 1, the example was described in which an average value is used as the interpolation method for the pixels not stored in the reference memory. In Modification 2, another interpolation method will be described.

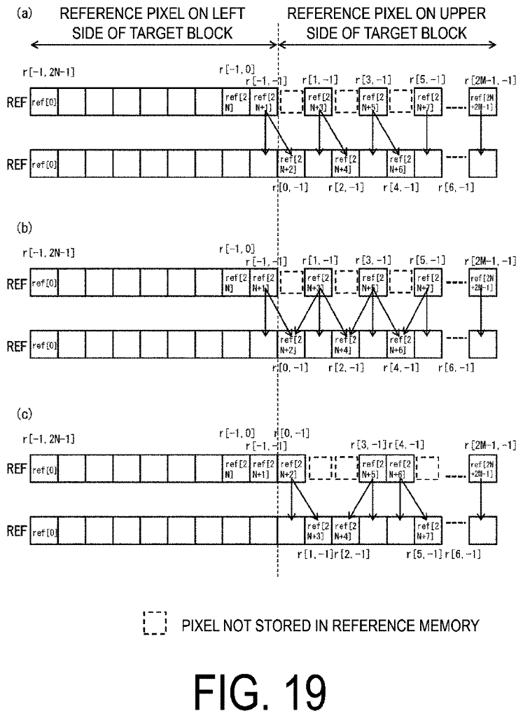

FIGS. 19(a) to (c) illustrate the internal memory storing the reference pixels as a one-dimensional array ref[ ]. In the drawings, ref[k] (k=0, . . . , 2N+1) (corresponding to the internal memory r[−1, 2N−1] to r[−1, −1] of the two-dimensional array in FIG. 10(b)) includes the reference pixels on the left side of the target block, ref[k] (k=2N+2, . . . , 2N+2M−1) (corresponding to r[0, −1] to r[2M−1, −1] in FIG. 10(b)) includes reference pixels on the upper side of the target block. For the reference pixels on the upper side of the target block, reference to odd-numbered positions is performed and reference to even-numbered positions is not performed in FIGS. 19(a) and 19(b), and reference to [4m, −1] and [4 m+3, −1] is performed and reference to [4 m+1, −1] and [4 m+2, −1] is not performed in FIG. 19(c). Pixels that are not referred to need not be held as reference memory.

FIG. 19(a) illustrates an example in which the pixel value r[2m, −1] at the even-numbered position is obtained by copying the pixel from the odd-numbered position.

ref[2N+2m]=ref[2N+2m−1](m=0, . . . ,M2−1)

This corresponds to the following two-dimensional memory.

r[2m,−1]=r[2m−1,−1](m=0, . . . ,M2−1)

An example in which the pixels at the odd-numbered positions of the reference memory are obtained by interpolation (copy) of the pixels from the even-numbered positions is described below.

ref[2N+2m+1]=ref[2N+2m]

This corresponds to the following two-dimensional memory.

r[2m+1,−1]=r[2m,−1](m=0, . . . ,M2−1)

FIG. 19(b) illustrates a configuration example in which, in the same manner as Embodiment 1, the pixel value ref[2N+2m] without reference to the reference memory, is interpolated with the average value of adjacent pixels.

ref[2N+2m]=(ref[2N+2m−1]+ref[2N+2m+1]+1)>>1(m=0, . . . ,M2−1)

This corresponds to the following two-dimensional memory.

r[2m,−1]=(r[2m−1,−1]+r[2m+1,−1]+1)>>1(m=0, . . . ,M2−1)

In the configuration without reference to pixels at the odd-numbered positions in the reference memory, the interpolation (averaging) is performed as described below.

ref[2N+2m+1]=(ref[2N+2m]+ref[2N+2m+2]+1)>>1(m=0, . . . ,M2−1)

r[2m+1,−1]=(r[2m,−1]+r[2m+2,−1]+1)>>1(m=0, . . . ,M2−1)

In the interpolation, a weighted average of the L+1 pixels in the vicinity may be used.

(the pixels at the even-numbered positions have not been not stored)

$$L \text{/} 2$$

$$r [ 2 m , - 1 ] = Σ w ( i + L \text{/} 2 ) * r [ 2 ( m + i ) - 1 , - 1 ] + 0.5$$

$$i = - L \text{/} 2$$

$$Σ w ( i ) = 1$$

(the pixels at the odd-numbered positions have not been not stored)

$$L \text{/} 2$$

$$r [ 2 m + 1 , - 1 ] = Σ w ( i + L \text{/} 2 ) * r [ 2 ( m + i ) , - 1 ] + 0.5 \\ i = - L \text{/} 2 \\ Σ w ( i ) = 1$$

Here, w(i) is the weight coefficient.

FIG. 19(c) illustrates an example in which, in the same manner as Modification 1, in a case that the pixels at positions [4m, N−1] and [4 m+3, N−1] are obtained by reference to the reference memory, and reference to the reference memory is not made for the pixels of [4 m+1, N−1] and [4 m+2, N−1], the pixel values r[4 m+1, −1] and r[4 m+2, −1] are obtained by copying adjacent pixels.

ref[2N+4m+1]=ref[2N+4m](m=0, . . . ,M2/2−1)

ref[2N+4m+2]=ref[2N+4m+3](m=0, . . . ,M2/2−1)

This corresponds to the following two-dimensional memory.

r[4m+1,−1]=r[4m,−1](m=0, . . . ,M2/2−1)

r[4m+2,−1]=r[4m+3,−1](m=0, . . . ,M2/2−1)

Note that the processing of reading the pixel to be referenced from the reference memory can be described below. The cases of the examples of FIGS. 19(a) and 19(b) are as follows.

ref[2N+2m−1]=refImg[xBlk+2m−1,yBlk−1]

The case of the continuous one-dimensional array is as follows.

ref[2N+2m−1]=z[xBlk/2+m]

The case of the example of FIG. 19(c) is as follows.

ref[2N+4m]=refImg[xBlk+4m,yBlk−1]

ref[2N+4m+3]=refImg[xBlk+4m+3,yBlk−1]

The case of the continuous one-dimensional array is as follows.

ref[2N+4m]=z[xBlk/2+m]

ref[2N+4m+3]=z[xBlk/2+m+1]

The method for generating the interpolation pixel by copying or averaging has an advantage that processing is simplified. The method of increasing the number of pixels required for the interpolation and using the weight coefficient requires slightly complex processing, but has an advantage that change between the reference pixels is smooth and the image quality is thus not degraded. In addition, by making the processing common to that of the reference pixel filter that is performed in the later stage, it is possible to suppress increase in the processing amount.

### Modification 3

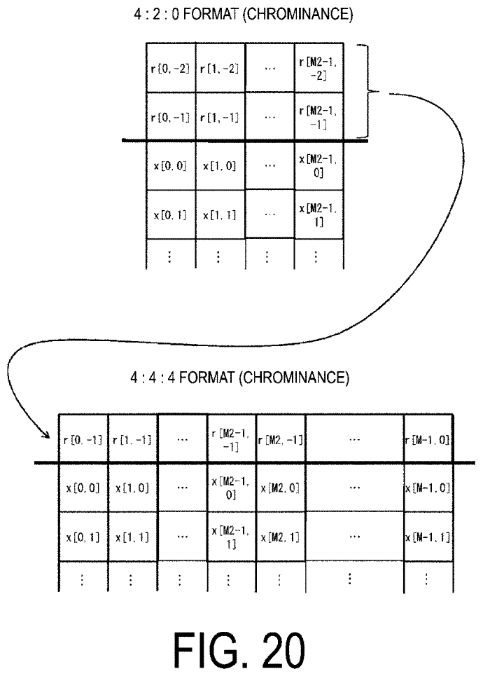

Modification 3 is an example in which the image processing apparatus and the image decoding apparatus have the loop filter configuration, and the reference memory for the loop filter and the reference memory for the intra prediction are commonly used. As described in FIG. 12 and the loop filter, the reference memory for at least two lines is required to perform the loop filtering. As illustrated in FIG. 20, by using reference memory for the two lines for the 4:2:0 format (FIG. 20(a)), the reference pixel for one line for the 4:4:4 format can be stored (FIG. 20(b)) in the chrominance component as well. In this case, it is not necessary to change the intra prediction processing. However, since the reference memory is used in common with the loop filter, it is necessary to change the reference pixels used in the loop filter to those for one line.

### Modification 4

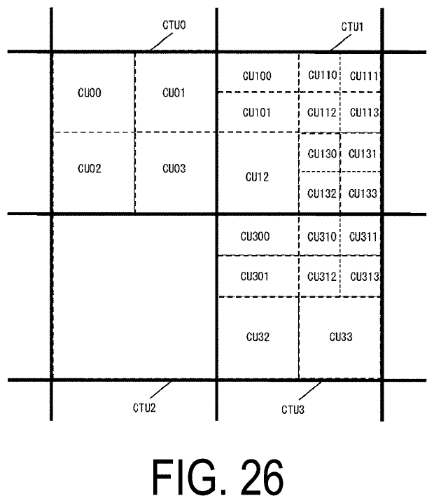

In a case that the decoding processing of the image decoding apparatus is performed in units of CTUs, the entire CTU information can be stored in the internal memory. Thus, in a case that the reference pixel for the intra prediction is in the same CTU, it is possible to read from the CTU internal memory. FIG. 26 is a diagram illustrating the CTU and the CU therein. In the diagram, a rectangle of a solid line indicates the CTU and a rectangle of a dashed line indicates the CU. For example, in a case of processing a CTU3, a CU301 can access a pixel of a CU300 that is the CU in the same CTU3 as the reference pixel on the upper side. However, the CU300 cannot access a pixel of a CU12 that is a CU in CTU1, which is different from the CTU thereof, as the pixel on the upper side. This is because the pixel of the different CTU1 is not present in the internal memory. In this way, the processing of reference across the bold line in FIG. 26 needs to read the pixel stored in the reference memory, and the restriction of the reference pixel described in Embodiment 1 can be used.

In Modification 4, at the CTU boundary, the intra prediction in which the pixels of the upper side CU is referred to is turned off, and at the CU boundary in the CTU, the intra prediction in which the pixels of the upper side CU is referred to is turned on. In other words, at the CTU boundary, in the intra prediction, only the pixels of the left side CU are referred to.

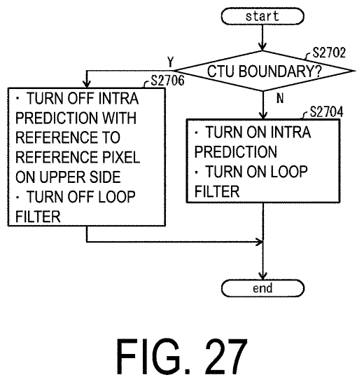

FIG. 27 is a flowchart illustrating operations of Modification 4. The image coding apparatus 11 or the image decoding apparatus 31 determines whether the CU boundary is the CTU boundary (S2702). The image coding apparatus 11 or the image decoding apparatus 31 proceeds to S2706 in a case of the CTU boundary (Y in S2702), and proceeds to S2704 in a case of not being the CTU boundary (N in S2702). In a case of not being the CTU boundary, the image coding apparatus 11 or the image decoding apparatus 31 turns on the normal intra prediction in which the pixels of the upper side CU and the left side CU are referred to (S2704). In a case of the CTU boundary, the image coding apparatus 11 or the image decoding apparatus 31 uses a prediction mode in which, in the intra prediction, only the reference pixels on the left side are referred to (S2706).

As described above, at the CTU boundary, by turning off the intra prediction in which the reference pixels on the upper side are referred to, it is possible to perform the intra prediction without using the pixels stored in the reference memory. Accordingly, the image decoding apparatus having the reference memory for decoding the coded data in the 4:2:0 format can decode the coded data in the 4:4:4 format.

### Modification 5

Modification 5 is another example of Embodiment 1 and Modifications 1 and 2 in which the reference pixels referred to in the intra prediction of the chrominance component are defined, regardless of the size and a storage method of the reference memory. In Modification 5, the pixel position in the horizontal direction is represented by the same coordinate system as that of the luminance component (the coordinate system of luminance in FIG. 10(b)). Therefore, in the 4:2:0 format, the pixel position of the chrominance component is expressed as [2m, 2n], and in the 4:4:4 format, the pixel position of the chrominance component is expressed as [m, n].

In the intra prediction, reference is made to only r[2 m−1, −1] at the odd-numbered positions illustrated in FIG. 10(b) as the reference pixels in the horizontal direction, located on the upper side of the block. Then, r[2m, −1] is interpolated by the method according to any one of Embodiment 1, Modification 1, and Modification 2. A case that the average value is used for calculating the pixels at the even-numbered positions is as follows.

r[2m,−1]=(r[2m−1,−1]+r[2m+1,−1]+1)>>1

A case that the pixels at the even-numbered positions are obtained by copying the reference pixels from the odd-numbered positions is as follows.

r[2m,−1]=r[2m−1,−1]

A case of calculating the pixels at the even-numbered positions by the weighted average is as follows.

$$L \text{/} 2$$

$$r [ 2 m , - 1 ] = Σ w ( i + L \text{/} 2 ) * r [ 2 ( m + i ) - 1 , - 1 ] + 0.5$$

$$i = - L \text{/} 2$$

$$Σ w ( i ) = 1$$

In the intra prediction, r[2 m−1, −1] and the interpolated r[2m, −1] are substituted into (Equation 1) to (Equation 3) to calculate the intra prediction value.

Note that in the reference pixels in the horizontal direction, by referring to the even-numbered positions r[2m, −1], the odd-numbered positions r[2 m+1, −1] may be calculated by the interpolation.

A case that the average value is used for calculating the pixels at the odd-numbered positions is as follows.

r[2m+1,−1]=(r[2m,−1]+r[2m+2,−1]+1)>>1

A case that the pixels at the odd-numbered positions are obtained by copying the reference pixels from the odd-numbered positions is as follows.

r[2m+1,−1]=r[2m,−1]

A case of calculating the pixels at the even-numbered positions by the weighted average is as follows.

$$L \text{/} 2$$

$$r [ 2 m + 1 , - 1 ] = Σ w ( i + L \text{/} 2 ) * r [ 2 ( m + i ) , - 1 ] + 0.5 \\ i = - L \text{/} 2 \\ Σ w ( i ) = 1$$

Additionally, by referring to r[4m, −1] and r[4 m+3, −1], r[4 m+1, −1] and r[4 m+2, −1] may be calculated by the interpolation.

r[4m+1,−1]=r[4m,−1]

r[4m+2,−1]=r[4m+3,−1]

By introducing the restriction on the reference pixels in this way, the intra prediction can be performed regardless of the size and the storage method of the reference memory. In addition, since only the restriction on the reference pixels is defined, devising in implementation, such as reducing cost by storing only pixels that refer to a small-sized memory that can be accessed at high speed, is easily possible.

### Embodiment 2

### Loop Filter

FIG. 15(b) illustrates an example of a state in which, in the 4:2:0 format-compliant image decoding apparatus, a reference pixel of the chrominance component is stored in the internal memory from the reference memory in order to apply the loop filter to the CTU block boundary of the coded data of the 4:4:4 format. Since the coded data are in the 4:4:4 format, the target block Q (pixels q[m, n], m=0, . . . , M−1, n=0, . . . , N−1) of the chrominance component has pixels of the same size (M*N) as the luminance component. However, in a block P one block line above the target block required for the loop filter (pixel p[m, n], m=0, . . . , M−1, n=0, . . . , N−1), two lines adjacent to the block Q are stored in the reference memory, the chrominance component of the 4:2:0 format is half the chrominance component of the 4:4:4 format, and therefore only pixels half the required pixels can be stored. Accordingly, in FIG. 15(b), there are no reference pixels at even-numbered positions p[2m, 0] and p[2m, 1] in the block P, but these reference pixels are essential for the loop filter (deblocking filter, EO of SAO, ALF) to the pixels at the block boundary. Furthermore, the pixel p[2m, 0] that makes contact with the block boundary is not only referred to at the time of applying the filter, but p[2m, 0] itself is also subjected to the filter to change the pixel value. On the other hand, in the CTU block, a memory of the size necessary to store the chrominance component is included.

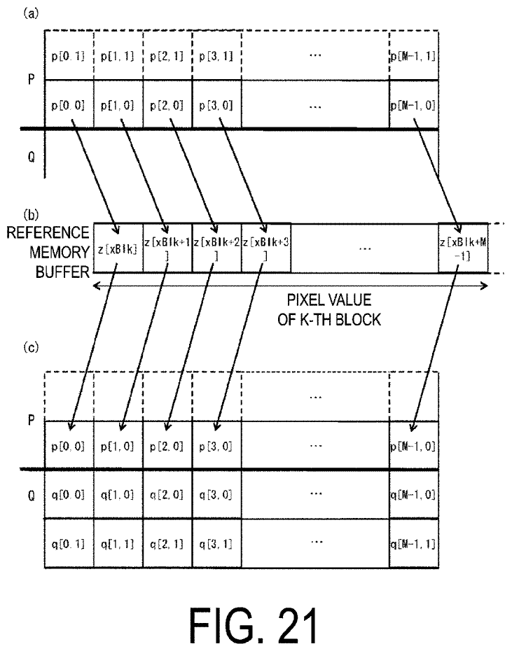

Therefore, in the image coding apparatus and the image decoding apparatus according to Embodiment 2, in a case of the 4:2:0 format or in a case of not being adjacent to the CTU block boundary in the 4:4:4 format, for the two lines on the upper side of the block boundary, reference from the internal memory is performed, and in a case of being adjacent to the CTU block in the 4:4:4 format, for the one line on the upper side of block boundary, reference is performed. With this, for example, as illustrated in FIGS. 21(a) to 21(c), in a case that the decoded pixel values p[m, N−1] and p[m, N−2] of the internal memory are stored in the reference memory, all pixels of the lowermost line of the block P in the 4:4:4 format can be stored using the reference memory for the two lines of the chrominance component for the 4:2:0 format with only half resolution in the horizontal direction. In the 4:2:0 format, processing is possible because the line memories for two lines are held for the loop filter of the chrominance. That is, a reference memory Z of FIG. 21(b) (element z[ ] of the array) stores the pixels of the lowermost line of a k-th block P.

z[xBlk+m]=p[m,0](m=0, . . . ,M−1)

This processing is equivalent to the following in a case of being described with the two-dimensional memory.

refImg[xBlk+m,yBlk+N−1]=p[m,0](m=0, . . . ,M−1)

For reference at the filtering, in a case of reading out to the internal memory, as illustrated in FIG. 21(c), reference is made to the pixel value of the reference memory Z.

p[m,0]=z[xBlk+m](m=0, . . . ,M−1)

This processing is equivalent to the following in a case of being described with the two-dimensional memory.

p[m,0]=refImg[xBlk+m,yBlk−1](m=0, . . . ,M−1)

In the internal memory, in a configuration without reference to the second line from the bottom of the block P, in a case of crossing the boundary of the CTU block, the method of calculating the target pixel and the reference pixel of the loop filter are changed. Detailed description will be given below.

### Deblocking Filter, EO of SAO

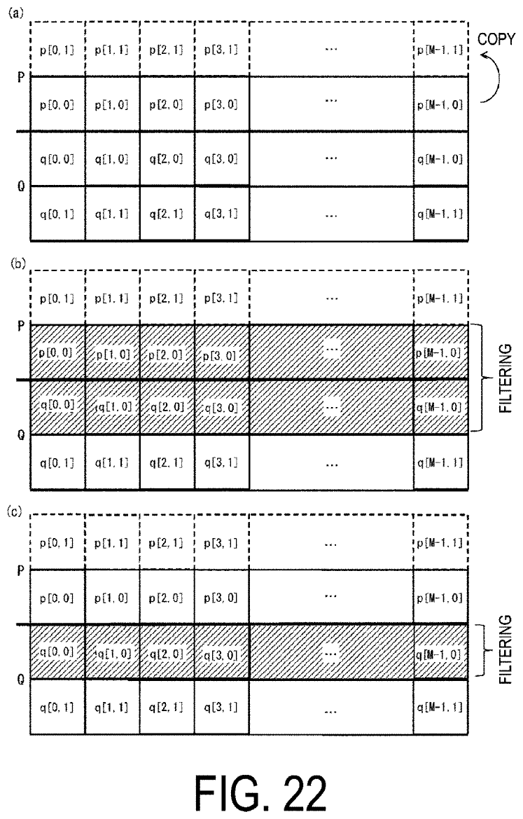

FIG. 22(a) illustrates the same situation as that in which the pixel p[m, 0] in the lowermost line of the block P is read and stored from the reference memory in FIG. 21(c). For the pixels p[m, 1] in the second line, which are indicated by dashed lines, from the bottom of the block P, reference to the reference memory is not made. That is, in a case of the chrominance component, the 4:4:4 format, and crossing the boundary of the CTU block (yBlk=yBlk/CTU size*CTU size), the loop filter 107 or 305 refers to the lowermost line of the reference memory refImg for the first line from the horizontal boundary of the block P, and derives the second line from the horizontal boundary of the block p by copying the value of the reference pixel p[m, 0] of the lowermost line of the same block.

p[m,0]=refImg[xBlk+m,yBlk−1](m=0, . . . ,M−1)

p[m,1]=p[m,0](m=0, . . . ,M−1)

Other cases (luminance component, 4:2:0 format, or yBlk!=yBlk/CTU size*CTU size) are as follows.

p[m,0]=refImg[xBlk+m,yBlk−1](m=0, . . . ,M−1)

p[m,1]=refImg[xBlk+m,yBlk−2](m=0, . . . ,M−1)

In the deblocking filter, in a case that it is determined that the deblocking filtering is to be performed, q[m, 1], q[m, 0], p[m, 0] and p[m, 1] generated by copying are substituted into (Equation 4) to calculate the pixel values q[m, 0] and p[m, 0] after the filtering.

In the EO of the SAO, an offset P selected by referring to p[m−1, 0], p[m+1, 0], q[m−1, 0], q[m, 0], and q[m+1, 0], and p[m−1, 1], p[m, 1], and p[m+1, 1], which are generated by copying, is substituted into (Equation 5) to calculate the p[m, 0] after the filtering. Furthermore, an offset Q selected by referring to p[m−1, 0], p[m, 0], p[m+1, 0], q[m−1, 0], q[m+1, 0], q[m−1, 1], q[m, 1], and q[m+1, 1] is substituted into (Equation 5) to calculate the q[m, 0] after the filtering.

As described above, in the deblocking filter and the EO of the SAO, as illustrated in FIG. 22(b), the pixels of the two lines at the boundary between the blocks P and the Q can be subjected to the filtering.

FIG. 17(b) is a flowchart illustrating operations described above. In the flowchart, S1416, S1422, and S1424 are the same operations as those in FIG. 14(b), and description thereof is omitted. The loop filter 107 or 305 reads the reference pixels (for example, z[xBlk+m] in FIG. 21(b)) required for prediction of the target block from the reference memory, and stores the read pixels in an internal memory p[m, 0] (not illustrated) of the loop filter 107 or 305 (S1714).

p[m,0]=z[xBlk+m](m=0, . . . ,M−1)

This processing is equivalent to the following in a case of being described with the two-dimensional memory.

p[m,0]=refImg[xBlk+m,yBlk−1](m=0, . . . ,M−1)

The loop filter 107 or 305 copies the M reference pixels p[m, 0] of the internal memory to the reference pixels p[m, 1] (S1715).

p[m,1]=p[m,0](m=0, . . . ,M−1)

By using the reference pixels read from the reference memory, the reference pixels obtained by copying thereof, and the reference pixels of the internal memory, the filtering is performed (S1416). The loop filter 107 or 305 stores the lowermost line of the block Q in the reference memory (S1720).

This method is the same processing as in the existing method except that the processing in which the one line of the block P, which is read from the reference memory and stored in the internal memory, is copied to the internal memory is added, and it is thus easy to change.

### Modification 6

In the deblocking filter of Embodiment 2, as illustrated in FIG. 22(b), an example has been described in which filtering is performed on the pixels p[m, 0] and q[m, 0] at the block boundary. In Modification 6, an example in which filtering is performed on the pixels q[m, 0] at the block boundary will be described.

As illustrated in FIG. 22(c), in Modification 4, filtering is performed on the pixels q[m, 0] at the block boundary in a case of the chrominance component, the 4:4:4 format, and crossing the boundary of the CTU block (yBlk=yBlk/CTU size*CTU size), but the filter is not applied to p[m, 0]. In one method, the filtering of (Equation 5) performed in Embodiment 2 is performed only on q[m, 0]. In this case, other processing is completely the same as that in Embodiment 2.

As another method, q[m, 0] is calculated in accordance with the following equation.

q[m,0]=(a1*q[m,0]+a2*p[m,0]+a3*q[m,1]+4)>>3

a1+a2+a3=8

For example, a1=4, a2=3, a3=1 are satisfied.

In this method, since p[m, 1] is not referred to, unlike Embodiment 2, a copy from p[m, 0] to p[m, 1] does not occur.

Note that in a case other than that described above (luminance component, 4:2:0 format, or yBlk!=yBlk/CTU size*CTU size), all p[m, 0], p[m, 1], q[m, 0], and q[m, 1] may be referred to and the filter processing may be performed as usual.

### Modification 7

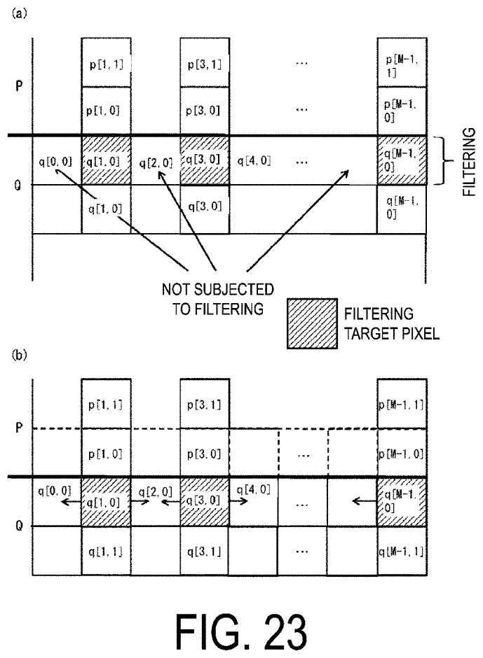

In Embodiment 2, processing of the deblocking filter and the EO of the SAO has been described in a case that all of the pixels in the lowermost line of the upper side block P of the target block Q are referred to from the reference memory. In Modification 7, as illustrated in FIG. 23(a), description will be given of processing of the deblocking filter in a case that pixels for two lines at odd-numbered positions of the block P stored on the reference memory are referred to, and the pixels at even-numbered positions are not referred to. The following description is given for a case of the chrominance component, the 4:4:4 format, and crossing the boundary of the CTU block (yBlk=yBlk/CTU size*CTU size), and in cases other than that, the processing which has already been described may be performed.

As illustrated in FIG. 23(a), in odd-numbered positions, all pixels required for the deblocking filter (p[2 m+1, 1], p[2 m+1, 0], q[2 m+1, 0], q[2 m+1, 1], m=0, . . . , M2−1) are provided and are substituted into (Equation 4) to perform the deblocking processing of q[2 m+1, 0]. Filtering of p[m, 0] is not performed.

Next, the pixel q[2m, 0] at the even-numbered position is corrected using the pixel, which has been subjected to the deblocking, at the odd-numbered position.

q[2m,0]=(q[2m−1,0]+6*q[2m,0]+q[2m+1,0]+4)>>3

In addition, it is also preferable to add clip processing to the correction range as described below.

Δq=Clip3(−tc,tc,(q[2m−1,0]−2*q[2m,0]+q[2m+1,0]+4)>>3)

q[2m,0]=Clip1(q[2m,0]+Δq)

Additionally, as described below, a correction value derived in the deblocking process at the odd-numbered position (position [2 m−1, 0]) may be used for correction processing of the even-numbered position.

Δ=Clip3(−tc,tc,(((q[2m−1,0]−p[2m−1,0])<<2)+p[2m−1,1]−q[2m−1,1]+4)>>3)

q[2m,0]=Clip1(q[2m,0]−Δ)

The odd-numbered positions may be 2 m+1 instead of 2 m−1.

Additionally, the following equation utilizing both 2 m+1 and 2 m−1 as the odd-numbered positions may be used.

Δp=(q[2m−1,0]−p[2m−1,0])<<2)+p[2m−1,1]−q[2m−1,1]

Δm=(q[2m+1,0]−p[2m+1,0])<<2)+p[2m+1,1]−q[2m+1,1]

Δ=Clip3(−tc,tc,(Δp+Δm+8)>>4)

q[2m,0]=Clip1(q[2m,0]−Δ)

As described above, only the pixels at the odd-numbered positions are stored in the reference memory, the deblocking filtering is performed with reference to four pixels at the odd-numbered positions, and the pixels of the even-numbered positions are interpolated and calculated, from the pixels after applying the deblocking filter at the odd-numbered positions, whereby the coded data in the 4:4:4 format can be decoded even with the reference memory having a size for the 4:2:0 format.

Note that in Modification 5, an example has been described in which the reference memory is referred to for the pixel at the odd-numbered position of the block P, but a configuration in which the reference memory is referred to for the pixel at the even-numbered position of the block P may be employed. In this case, 2 m described above is replaced with 2 m+1 (or 2 m−1).

### ALF

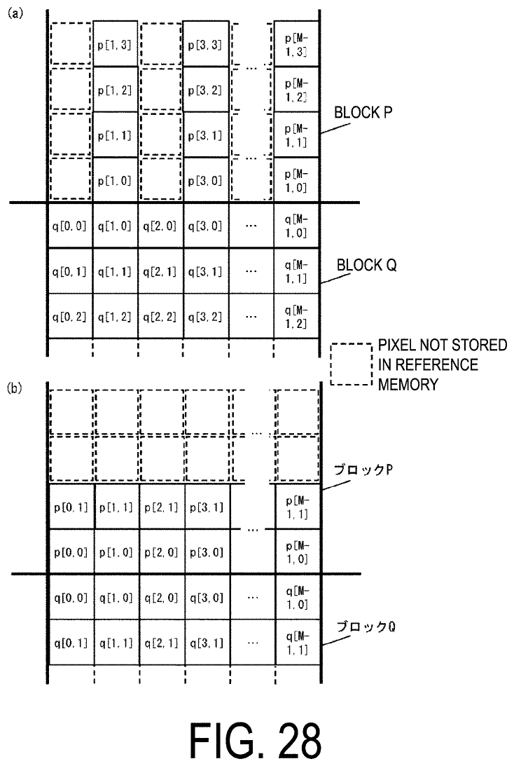

FIG. 28(a) illustrates an example of a state in which, in the 4:2:0 format-compliant image decoding apparatus, reference pixels of the chrominance component are stored in the internal memory from the reference memory in order to apply the ALF to the coded data of the 4:4:4 format at the CTU block boundary. The pixel indicated by the solid line is a pixel to be stored in the reference memory, and the pixel indicated by the dashed line is a pixel not to be stored in the reference memory. Since the coded data are in the 4:4:4 format, the target block Q (pixels q[m, n], m=0, . . . , M−1, n=0, . . . , N−1) of the chrominance component has pixels of the same size (M*N) as the luminance component. However, in a block P one block line above the target block required for the ALF (pixel p[m, n], m=0, . . . , M−1, n=0, . . . , N−1), four lines adjacent to the block Q are stored in the reference memory, the chrominance component of the 4:2:0 format is half the chrominance component of the 4:4:4 format, and therefore only pixels half the required pixels can be stored. Accordingly, in FIG. 28(a), there are no reference pixels at even-numbered positions p[2m, 0], p[2m, 1], p[2m, 2], and p[2m, 3] in the block P, but these reference pixels are essential for the ALF to the pixels at the block boundary. Furthermore, the pixels p[2m, 0] and p[2m, 1] that make contact with the block boundary are not only referred to at the time of applying the filter, but p[2m, 0] and p[2m, 1] themselves are also subjected to the filter to change the pixel values. On the other hand, in the CTU block, a memory of the size necessary to store the chrominance component is included.

Therefore, in the image coding apparatus and the image decoding apparatus according to Embodiment 2, in a case of the 4:2:0 format or in a case of not being adjacent to the CTU block in the 4:4:4 format, the four lines on the upper side of the block boundary are referred to from the internal memory, and in a case of being adjacent to the CTU block in the 4:4:4 format, the two lines on the upper side of block boundary are referred to. In other words, for example, as illustrated in FIG. 28(b), in a case that the decoded pixels of the internal memory are stored in the reference memory, the pixels of the lowermost two lines of the block P in the 4:4:4 format are stored in the reference memory for the four lines of the chrominance component for the 4:2:0 format with only half resolution in the horizontal direction. In the 4:2:0 format, this processing is possible because the line memories for four lines are held for the loop filter of the chrominance. The reference memory Z (element z[ ] of the array) stores the pixels of the lowermost two line of a k-th block P.

z[xBlk+m]=p[m,0](m=0, . . . ,M−1)

z[xBlk+width+m]=p[m,1](m=0, . . . ,M−1)

Here, width represents size of the image in the horizontal direction.

This processing is equivalent to the following in a case of being described with the two-dimensional memory.

refImg[xBlk+m,yBlk+N−1]=p[m,0](m=0, . . . ,M−1)

refImg[xBlk+m,yBlk+N−2]=p[m,1](m=0, . . . ,M−1)

For reference at the filtering, in a case of reading out to the internal memory, as described below, reference is made to the pixel value of the reference memory Z.

p[m,0]=z[xBlk+m](m=0, . . . ,M−1)

p[m,1]=z[xBlk+width+m](m=0, . . . ,M−1)

This processing is equivalent to the following in a case of being described with the two-dimensional memory.

p[m,0]=refImg[xBlk+m,yBlk−1](m=0, . . . ,M−1)

p[m,1]=refImg[xBlk+m,yBlk−2](m=0, . . . ,M−1)

Here, xBlk and yBlk are an upper left coordinate of the block Q.

In the internal memory, in a configuration in which reference only to the two lines from the bottom of the block P is performed, in a case of crossing the boundary of the CTU block, the method of calculating the target pixel and the reference pixel of the ALF are changed. Detailed description will be given below.

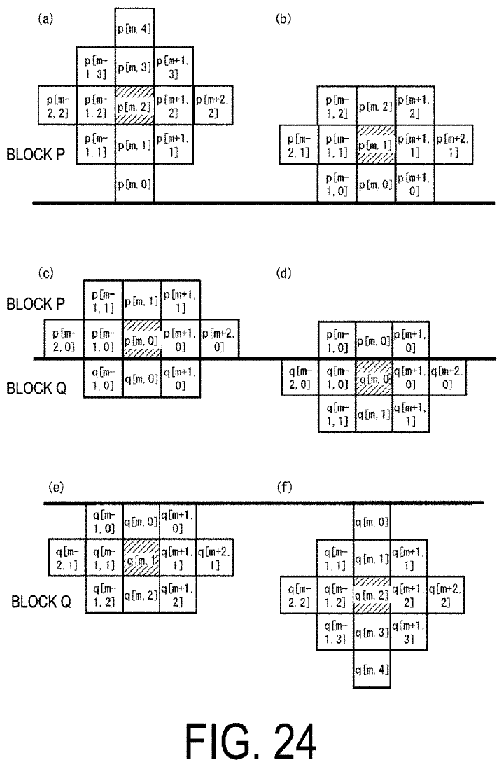

As illustrated in FIGS. 12(d) to 12(g), in a case of applying the ALF, the chrominance component normally requires the reference memory for four lines. In the present application, as illustrated in FIG. 24, a technique will be described in which the ALF is applied with the reference memory for two lines by changing the ALF filter shape of the chrominance component at the CTU block boundary. In the same manner as the intra prediction, the deblocking filter, and the SAO (EO), the following is performed in a case of the chrominance component, the 4:4:4 format, and crossing the boundary of the CTU block (yBlk=yBlk/CTU size*CTU size), and in cases other than that, the normal processing may be performed.

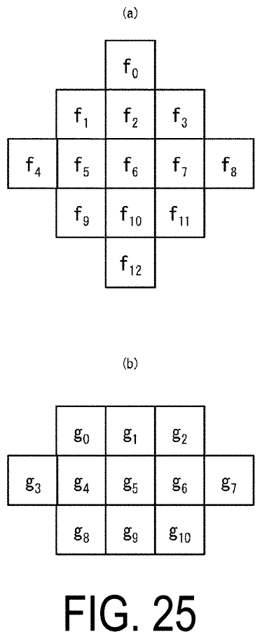

In FIG. 24(a), p[m, 2] indicated by the diagonal lines is a pixel on the lowermost line in the block P in which the existing ALF can be applied with only the pixels in the block P. The pixel indicated by the diagonal lines is the target pixel for the filtering, and the white pixels are reference pixels. Additionally, a boundary between the blocks P and Q indicated by a bold line in the diagram is the boundary between the CTU blocks. Normally, p[m, 1] needs to refer to the pixel of the block Q as illustrated in FIG. 12(d). Additionally, up to q[m, 1] illustrated in FIG. 12(g), the ALF cannot be applied by only pixels of the block itself. However, as illustrated in FIGS. 24(b) to 24(e), changing the ALF filter shape from 5×5 to 5×3 at the CTU block boundary makes it possible to reduce the referenced memory to two lines. By changing the filter shape to 5×3, as illustrated in FIG. 24(b), for p[m, 1] as well, the ALF can be applied with only the pixels in the block P. Additionally, as illustrated in FIG. 24(e), for q[m, 1] as well, the ALF can be applied with only the pixels in the block P. On the other hand, only for the p[m, 0] in FIG. 24(c) and q[m, 0] in FIG. 24(d), the ALF cannot be applied with only the pixels in the block itself. The reference memory required at this time is two lines as illustrated in FIGS. 24(c) and 24(d). In a case of assuming that FIG. 25(a) illustrates a filter coefficient for the ALF of 5×5 and FIG. 25(b) illustrates a filter coefficient of the ALF of 5×3, the ALF can be expressed as follows.

A case of n>=2 is as follows.

p[m,n]=f0*p[m,n+2]+f1*p[m−1,n+1]+f2*p[m,n+1]+f3*p[m+1,n+1]+f4*p[m−2,n]+f5*p[m−1,n]+f6*p[m,n]+f7*p[m+1,n]+f8*p[m+2,n]+f9*p[m−1,n−1]+f10*p[m,n−1]+f11*p[m+1,n−1]+f12*p[m,n−2]

Calculation of q[x, y] is performed by an equation in which p[x, y] is replaced by q[x, y].

A case of n=1 is as follows.

p[m,n]=g0*p[m−1,n+1]+g1*p[m,n+1]+g2*p[m+1,n+1]+g3*p[m−2,n]+g4*p[m−1,n]+g5*p[m,n]+g6*p[m+1,n]+g7*p[m+2,n]+g8*p[m−1,n−1]+g9*p[m,n−1]+g10*p[m+1,n−1]

Calculation of q[x, y] is performed by an equation in which p[x, y] is replaced by q[x, y].

A case of n=0 is as follows.

p[m,n]=g0*p[m−1,n+1]+g1*p[m,n+1]+g2*p[m+1,n+1]+g3*p[m−2,n]+g4*p[m−1,n]+g5*p[m,n]+g6*p[m+1,n]+g7*p[m+2,n]+g8*q[m−1,n]+g9*q[m,n]+g10*q[m+1,n]

Calculation of q[x, y] is performed by an equation in which p[x, y] is replaced by q[x, y].

Note that, in the above description, the example has been described in which the filter shape is changed from S×S=5×5 to 5×3, but in a case of an S×(S−2) tap filter, the configuration is not limited to the above example, and it is sufficient that memory for (S−3) lines is prepared.

As described above, in a case of applying the filter to the chrominance component, the ALF uses the 5×3 filter in a diamond shape in a case of the 4:4:4 format and the CTU block boundary (yBlk=yBlk/CTU size*CTU size), and uses the 5×5 filter in a diamond shape in other cases. As described above, by changing the filter shape, the 4:2:0 format-compliant image decoding apparatus can decode the coded data of the 4:4:4 format.

Note that the reference memory for the four lines of the 4:2:0 format has the same size as that of the memory for the two lines of the 4:4:4 format. Accordingly, in a case of sharing the reference memory with the ALF, in the intra prediction, the deblocking filter, and the EO of the SAO, normal processing can be performed.

### Modification 8

As yet another example, Modification 8 describes a technique in which the loop filter that refers to the pixels of the upper side CU at the CTU boundary is turned off and the loop filter is turned on at the CU boundary within the CTU.

FIG. 27 is a flowchart illustrating operations of Modification 8. The image coding apparatus 11 or the image decoding apparatus 31 determines whether the CU boundary is the CTU boundary (S2702). The image coding apparatus 11 or the image decoding apparatus 31 proceeds to S2706 in a case of the CTU boundary (Y in S2702), and proceeds to S2704 in a case of not being the CTU boundary (N in S2702). In a case of not being the CTU boundary, the image coding apparatus 11 or the image decoding apparatus 31 turns on the loop filter (S2704). In a case of the CTU boundary, the image coding apparatus 11 or the image decoding apparatus 31 turns off the loop filter (S2706).

As described above, at the CTU boundary, by turning off the loop filter, it is possible to perform the loop filtering without using the pixels stored in the reference memory. Accordingly, the image decoding apparatus having the line memory for decoding the coded data in the 4:2:0 format can decode the coded data in the 4:4:4 format.

An image coding apparatus according to an aspect of the present invention includes: a unit configured to split a picture of the input video to a block including multiple pixels; a predictor configured to, by taking the block as a unit, refer to a pixel (a reference pixel) of an adjacent block of a target block, perform an intra prediction, and calculate a prediction pixel value; a unit configured to subtract the prediction pixel value from the input video and calculate a first prediction error; a unit configured to perform transformation and quantization on the prediction error and output a quantized transform coefficient; and a unit configured to perform variable-length coding on the quantized transform coefficient, in which the predictor refers to a pixel of a block on a left side and a pixel of a block on an upper side of the target block on which the intra prediction is performed, refers to, in the chrominance component, for a reference pixel of the block on the upper side, one pixel (a first reference pixel) for every two pixels of the target block, and derives a remaining one pixel (a second reference pixel) by interpolation from the first reference pixel, and the predictor refers to the first reference pixel and the second reference pixel and calculates an intra prediction value of each pixel of the chrominance component of the target block.

Furthermore, in the image coding apparatus according to the aspect of the present invention, the first reference pixel may be a pixel at an odd-numbered pixel position, and the second reference pixel may be a pixel at an even-numbered pixel position.

Furthermore, in the image coding apparatus according to the aspect of the present invention, the first reference pixel may be a pixel at an even-numbered pixel position, and the second reference pixel may be a pixel at an odd-numbered pixel position.

An image decoding apparatus according to an aspect of the present invention includes: a unit configured to, by taking a block including multiple pixels as a processing unit, perform variable-length decoding on coded data and output a quantized transform coefficient; a unit configured to perform inverse quantization and inverse transformation on the quantized transform coefficient and output a second prediction error; a predictor configured to, by taking the block as a unit, refer to a pixel (a reference pixel) of an adjacent block of a target block, perform an intra prediction, and calculate a prediction pixel value; and a unit configured to add the prediction pixel value and the prediction error, in which the predictor refers to a pixel of a block on a left side and a pixel of a block on an upper side, of the target block on which the intra prediction is performed, refers to, in the chrominance component, for a reference pixel of the block on the upper side, one pixel (a first reference pixel) for every two pixels of the target block, and derives a remaining one pixel (a second reference pixel) by interpolation from the first reference pixel, and the predictor refers to the first reference pixel and the second reference pixel and calculates an intra prediction value of each pixel of the chrominance component of the target block.

Furthermore, in the image decoding apparatus according to the aspect of the present invention, the first reference pixel may be a pixel at an odd-numbered pixel position, and the second reference pixel may be a pixel at an even-numbered pixel position.

Furthermore, in the image decoding apparatus according to the aspect of the present invention, the first reference pixel may be a pixel at an even-numbered pixel position, and the second reference pixel may be a pixel at an odd-numbered pixel position.

A deblocking filter device according to an aspect of the present invention includes: a memory configured to store a pixel referred to at filtering; and a filter unit configured to perform filter processing with reference to T pixels including a reference pixel read from the memory and a target pixel for filtering, in which at a horizontal boundary of two blocks, for a chrominance component, a target pixel (a first target pixel) for T/4 lines of a block on an upper side is read from the memory, a reference pixel (a third reference pixel) for T/4 lines of the block on the upper side that is not read from the memory is derived by copying the first target pixel, the filter unit refers to the first target pixel, the third reference pixel, and a pixel of the target block and calculates a target pixel for filtering of the chrominance component.

A loop filter device according to an aspect of the present invention includes: a memory configured to store a pixel referred to at filtering; and a filter unit configured to apply a filter with a diamond shape to a chrominance component with reference to pixels configured to include a reference pixel read from the memory and a target pixel for filtering, in which at a horizontal boundary of two blocks, for the chrominance component, a pixel for S−3 lines on a block boundary side (a first target pixel) of pixels of a block on an upper side is read from the memory, the filter unit is configured to perform, by applying a filter with an S×S diamond shape to a pixel for (S/2+1) lines from a block boundary, and by applying a filter with an S×(S−2) diamond shape to a pixel for S/2 lines from the block boundary, of pixels of blocks configured to border at the horizontal boundary, filtering on the chrominance component.

Furthermore, in the loop filter device according to the aspect of the present invention, in a case that the block is a coding unit (a CU), the processing may not be performed, and in a case that the block is a coding tree unit (a CTU), the processing may be performed.

An image decoding apparatus according to an aspect of the present invention includes: a unit configured to, by taking a block including multiple pixels as a processing unit, perform variable-length decoding on coded data and output a quantized transform coefficient; a unit configured to perform inverse quantization and inverse transformation on the quantized transform coefficient and output a second prediction error; a predictor configured to, by taking the block as a unit, refer to a pixel (a reference pixel) of an adjacent block of a target block, perform an intra prediction, and calculate a prediction pixel value; a unit configured to add the prediction pixel value and the prediction error and derive a decoded image; and a filtering unit configured to perform filtering on the decoded image, in which in the predictor or the filtering unit, processing to be performed in a case that a block boundary is a CU boundary is different from processing to be performed in a case that the block boundary is a CTU boundary.

An image coding apparatus according to an aspect of the present invention includes: a unit configured to split a picture of the input video to a block including multiple pixels; a predictor configured to, by taking the block as a unit, refer to a pixel (a reference pixel) of an adjacent block of a target block, perform an intra prediction, and calculate a prediction pixel value; a unit configured to subtract the prediction pixel value from the input video and calculate a first prediction error; a unit configured to perform transformation and quantization on the prediction error and output a quantized transform coefficient; a unit configured to perform variable-length coding on the quantized transform coefficient; a unit configured to perform inverse quantization and inverse transformation on the quantized transform coefficient and output a second prediction error; a unit configured to add the prediction pixel value and the prediction error and derive a decoded image; and a filtering unit configured to perform filtering on the decoded image, in which in the predictor or the filtering unit, processing to be performed in a case that a block boundary is a CU boundary is different from processing to be performed in a case that the block boundary is a CTU boundary.

### Implementation Examples by Software

Note that, part of the image coding apparatus 11 and the image decoding apparatus 31 in the above-mentioned embodiments, for example, the entropy decoding unit 301, the prediction parameter decoding unit 302, the loop filter 305, the prediction image generation unit 308, the inverse quantization and inverse transformation unit 311, the addition unit 312, the prediction image generation unit 101, the subtraction unit 102, the transformation and quantization unit 103, the entropy coder 104, the inverse quantization and inverse transformation unit 105, the loop filter 107, the coding parameter determination unit 110, and the prediction parameter coding unit 111, may be realized by a computer. In that case, this configuration may be realized by recording a program for realizing such control functions on a computer-readable recording medium and causing a computer system to read the program recorded on the recording medium for execution. Note that it is assumed that the “computer system” mentioned here refers to a computer system built into either the image coding apparatus 11 or the image decoding apparatus 31, and the computer system includes an OS and hardware components such as a peripheral apparatus. Furthermore, the “computer-readable recording medium” refers to a portable medium such as a flexible disk, a magneto-optical disk, a ROM, a CD-ROM, and the like, and a storage apparatus such as a hard disk built into the computer system. Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Part or all of the image coding apparatus 11 and the image decoding apparatus 31 in the embodiments described above may be realized as an integrated circuit such as a Large Scale Integration (LSI). Each function block of the image coding apparatus 11 and the image decoding apparatus 31 may be individually realized as processors, or part or all may be integrated into processors. The circuit integration technique is not limited to LSI, and the integrated circuits for the functional blocks may be realized as dedicated circuits or a multi-purpose processor. In a case that with advances in semiconductor technology, a circuit integration technology with which an LSI is replaced appears, an integrated circuit based on the technology may be used.

### Application Examples

The above-mentioned image coding apparatus 11 and the image decoding apparatus 31 can be utilized being installed to various apparatuses performing transmission, reception, recording, and regeneration of videos. Note that, videos may be natural videos imaged by cameras or the like, or may be artificial videos (including CG and GUI) generated by computers or the like.

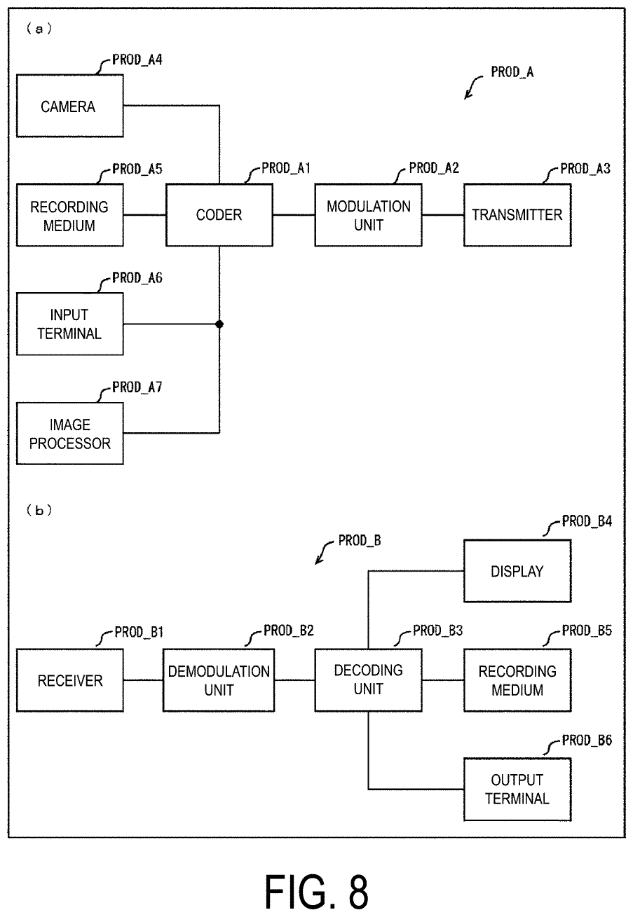

At first, referring to FIG. 8, it will be described that the above-mentioned image coding apparatus 11 and the image decoding apparatus 31 can be utilized for transmission and reception of videos.

(a) of FIG. 8 is a block diagram illustrating a configuration of a transmitting apparatus PROD_A installed with the image coding apparatus 11. As illustrated in (a) of FIG. 8, the transmitting apparatus PROD_A includes a coder PROD_A1 which obtains coded data by coding videos, a modulation unit PROD_A2 which obtains modulating signals by modulating carrier waves with the coded data obtained by the coder PROD_A1, and a transmitter PROD_A3 which transmits the modulating signals obtained by the modulation unit PROD_A2. The above-mentioned image coding apparatus 11 is utilized as the coder PROD_A1.

The transmitting apparatus PROD_A may further include a camera PROD_A4 imaging videos, a recording medium PROD_A5 recording videos, an input terminal PROD_A6 to input videos from the outside, and an image processor A7 which generates or processes images, as sources of supply of the videos input into the coder PROD_A1. In (a) of FIG. 8, although the configuration that the transmitting apparatus PROD_A includes these all is exemplified, a part may be omitted.

Note that the recording medium PROD_A5 may record videos which are not coded, or may record videos coded in a coding scheme for recording different than a coding scheme for transmission. In the latter case, a decoding unit (not illustrated) to decode coded data read from the recording medium PROD_A5 according to coding scheme for recording may be interleaved between the recording medium PROD_A5 and the coder PROD_A1.

(b) of FIG. 8 is a block diagram illustrating a configuration of a receiving apparatus PROD_B installed with the image decoding apparatus 31. As illustrated in (b) of FIG. 8, the receiving apparatus PROD_B includes a receiver PROD_B1 which receives modulating signals, a demodulation unit PROD_B2 which obtains coded data by demodulating the modulating signals received by the receiver PROD_B1, and a decoding unit PROD_B3 which obtains videos by decoding the coded data obtained by the demodulation unit PROD_B2. The above-mentioned image decoding apparatus 31 is utilized as the decoding unit PROD_B3.

The receiving apparatus PROD_B may further include a display PROD_B4 displaying videos, a recording medium PROD_B5 to record the videos, and an output terminal PROD_B6 to output videos outside, as output destination of the videos output by the decoding unit PROD_B3. In (b) of FIG. 8, although the configuration that the receiving apparatus PROD_B includes these all is exemplified, a part may be omitted.

Note that the recording medium PROD_B5 may record videos which are not coded, or may record videos which are coded in a coding scheme for recording different from a coding scheme for transmission. In the latter case, a coder (not illustrated) to code videos acquired from the decoding unit PROD_B3 according to a coding scheme for recording may be interleaved between the decoding unit PROD_B3 and the recording medium PROD_B5.

Note that the transmission medium transmitting modulating signals may be wireless or may be wired. The transmission aspect to transmit modulating signals may be broadcasting (here, referred to as the transmission aspect where the transmission target is not specified beforehand) or may be telecommunication (here, referred to as the transmission aspect that the transmission target is specified beforehand). Thus, the transmission of the modulating signals may be realized by any of radio broadcasting, cable broadcasting, radio communication, and cable communication.

For example, broadcasting stations (broadcasting equipment, and the like)/receiving stations (television receivers, and the like) of digital terrestrial television broadcasting are an example of transmitting apparatus PROD_A/receiving apparatus PROD_B transmitting and/or receiving modulating signals in radio broadcasting. Broadcasting stations (broadcasting equipment, and the like)/receiving stations (television receivers, and the like) of cable television broadcasting are an example of transmitting apparatus PROD_A/receiving apparatus PROD_B transmitting and/or receiving modulating signals in cable broadcasting.

Servers (work stations, and the like)/clients (television receivers, personal computers, smartphones, and the like) for Video On Demand (VOD) services, video hosting services using the Internet and the like are an example of transmitting apparatus PROD_A/receiving apparatus PROD_B transmitting and/or receiving modulating signals in telecommunication (usually, any of radio or cable is used as transmission medium in the LAN, and cable is used for as transmission medium in the WAN). Here, personal computers include a desktop PC, a laptop type PC, and a graphics tablet type PC. Smartphones also include a multifunctional portable telephone terminal.

Note that a client of a video hosting service has a function to code a video imaged with a camera and upload the video to a server, in addition to a function to decode coded data downloaded from a server and to display on a display. Thus, a client of a video hosting service functions as both the transmitting apparatus PROD_A and the receiving apparatus PROD_B.

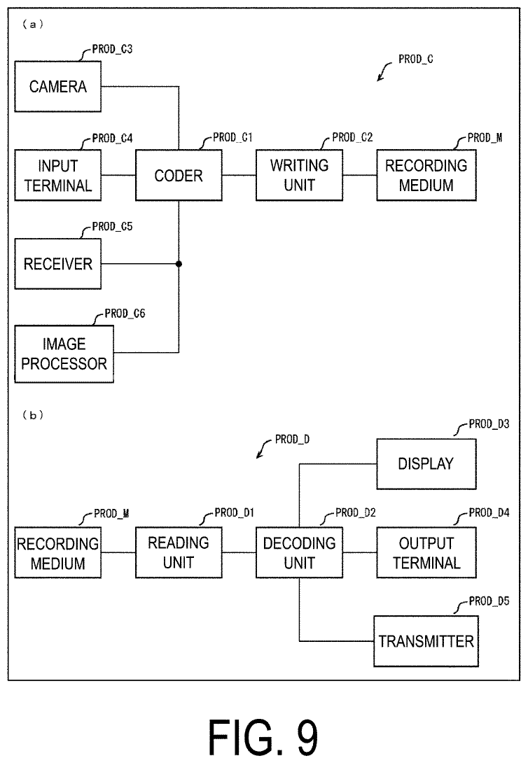

Next, referring to FIG. 9, it will be described that the above-mentioned image coding apparatus 11 and the image decoding apparatus 31 can be utilized for recording and regeneration of videos.

(a) of FIG. 9 is a block diagram illustrating a configuration of a recording apparatus PROD_C installed with the above-mentioned image coding apparatus 11. As illustrated in (a) of FIG. 9, the recording apparatus PROD_C includes a coder PROD_C1 which obtains coded data by coding a video, and a writing unit PROD_C2 which writes the coded data obtained by the coder PROD_C1 in a recording medium PROD_M. The above-mentioned image coding apparatus 11 is utilized as the coder PROD_C1.

Note that the recording medium PROD_M may be (1) a type built in the recording apparatus PROD_C such as Hard Disk Drive (HDD) or Solid State Drive (SSD), may be (2) a type connected to the recording apparatus PROD_C such as an SD memory card or a Universal Serial Bus (USB) flash memory, and may be (3) a type loaded in a drive apparatus (not illustrated) built in the recording apparatus PROD_C such as Digital Versatile Disc (DVD) or Blu-ray Disc (BD: trade name).

The recording apparatus PROD_C may further include a camera PROD_C3 imaging a video, an input terminal PROD_C4 to input the video from the outside, a receiver PROD_C5 to receive the video, and an image processor PROD_C6 which generates or processes images, as sources of supply of the video input into the coder PROD_C1. In (a) of FIG. 9, although the configuration that the recording apparatus PROD_C includes these all is exemplified, a part may be omitted.

Note that the receiver PROD_C5 may receive a video which is not coded, or may receive coded data coded in a coding scheme for transmission different from a coding scheme for recording. In the latter case, a decoding unit (not illustrated) for transmission to decode coded data coded in a coding scheme for transmission may be interleaved between the receiver PROD_C5 and the coder PROD_C1.

Examples of such recording apparatus PROD_C include a DVD recorder, a BD recorder, a Hard Disk Drive (HDD) recorder, and the like (in this case, the input terminal PROD_C4 or the receiver PROD_C5 is the main source of supply of a video). A camcorder (in this case, the camera PROD_C3 is the main source of supply of a video), a personal computer (in this case, the receiver PROD_C5 or the image processor C6 is the main source of supply of a video), a smartphone (in this case, the camera PROD_C3 or the receiver PROD_C5 is the main source of supply of a video), or the like is an example of such recording apparatus PROD_C.

(b) of FIG. 9 is a block diagram illustrating a configuration of a regeneration apparatus PROD_D installed with the above-mentioned image decoding apparatus 31. As illustrated in (b) of FIG. 9, the regeneration apparatus PROD_D includes a reading unit PROD_D1 which reads coded data written in the recording medium PROD_M, and a decoding unit PROD_D2 which obtains a video by decoding the coded data read by the reading unit PROD_D1. The above-mentioned image decoding apparatus 31 is utilized as the decoding unit PROD_D2.

Note that the recording medium PROD_M may be (1) a type built in the regeneration apparatus PROD_D such as HDD or SSD, may be (2) a type connected to the regeneration apparatus PROD_D such as an SD memory card or a USB flash memory, and may be (3) a type loaded in a drive apparatus (not illustrated) built in the regeneration apparatus PROD_D such as DVD or BD.

The regeneration apparatus PROD_D may further include a display PROD_D3 displaying a video, an output terminal PROD_D4 to output the video to the outside, and a transmitter PROD_D5 which transmits the video, as the output destination of the video output by the decoding unit PROD_D2. In (b) of FIG. 9, although the configuration that the regeneration apparatus PROD_D includes these all is exemplified, a part may be omitted.

Note that the transmitter PROD_D5 may transmit a video which is not coded, or may transmit coded data coded in a coding scheme for transmission different than a coding scheme for recording. In the latter case, a coder (not illustrated) to code a video in a coding scheme for transmission may be interleaved between the decoding unit PROD_D2 and the transmitter PROD_D5.

Examples of such regeneration apparatus PROD_D include a DVD player, a BD player, an HDD player, and the like (in this case, the output terminal PROD_D4 to which a television receiver, and the like is connected is the main output destination of the video). A television receiver (in this case, the display PROD_D3 is the main output destination of the video), a digital signage (also referred to as an electronic signboard or an electronic bulletin board, and the like, the display PROD_D3 or the transmitter PROD_D5 is the main output destination of the video), a desktop PC (in this case, the output terminal PROD_D4 or the transmitter PROD_D5 is the main output destination of the video), a laptop type or graphics tablet type PC (in this case, the display PROD_D3 or the transmitter PROD_D5 is the main output destination of the video), a smartphone (in this case, the display PROD_D3 or the transmitter PROD_D5 is the main output destination of the video), or the like is an example of such regeneration apparatus PROD_D.

Realization as Hardware and Realization as Software Each block of the above-mentioned image decoding apparatus 31 and the image coding apparatus 11 may be realized as a hardware by a logical circuit formed on an integrated circuit (IC chip), or may be realized as a software using a Central Processing Unit (CPU).

In the latter case, each apparatus includes a CPU performing a command of a program to implement each function, a Read Only Memory (ROM) storing the program, a Random Access Memory (RAM) developing the program, and a storage apparatus (recording medium) such as a memory storing the program and various data, and the like. The purpose of the embodiments of the present invention can be achieved by supplying, to each of the apparatuses, the recording medium recording readably the program code (execution form program, intermediate code program, source program) of the control program of each of the apparatuses which is a software implementing the above-mentioned functions with a computer, and by the computer (or a CPU or a MPU) reading and performing the program code recorded in the recording medium.

For example, as the recording medium, a tape such as a magnetic tape or a cassette tape, a disc including a magnetic disc such as a floppy (trade name) disk/a hard disk and an optical disc such as a Compact Disc Read-Only Memory (CD-ROM)/Magneto-Optical disc (MO disc)/Mini Disc (MD)/Digital Versatile Disc (DVD)/CD Recordable (CD-R)/Blu-ray Disc (trade name), a card such as an IC card (including a memory card)/an optical card, a semiconductor memory such as a mask ROM/Erasable Programmable Read-Only Memory (EPROM)/Electrically Erasable and Programmable Read-Only Memory (EEPROM) (trade name)/a flash ROM, or a Logical circuits such as a Programmable logic device (PLD) or a Field Programmable Gate Array (FPGA) can be used.

Each of the apparatuses is configured connectably with a communication network, and the program code may be supplied through the communication network. This communication network may be able to transmit a program code, and is not specifically limited. For example, the Internet, the intranet, the extranet, Local Area Network (LAN), Integrated Services Digital Network (ISDN), Value-Added Network (VAN), a Community Antenna television/Cable Television (CATV) communication network, Virtual Private Network, telephone network, a mobile communication network, satellite communication network, and the like are available. A transmission medium constituting this communication network may also be a medium which can transmit a program code, and is not limited to a particular configuration or a type. For example, a cable communication such as Institute of Electrical and Electronic Engineers (IEEE) 1394, a USB, a power line carrier, a cable TV line, a phone line, an Asymmetric Digital Subscriber Line (ADSL) line, and a radio communication such as infrared ray such as Infrared Data Association (IrDA) or a remote control, BlueTooth (trade name), IEEE 802.11 radio communication, High Data Rate (HDR), Near Field Communication (NFC), Digital Living Network Alliance (DLNA) (trade name), a cellular telephone network, a satellite channel, a terrestrial digital broadcast network are available. Note that the embodiments of the present invention can be also realized in the form of computer data signals embedded in a carrier wave where the program code is embodied by electronic transmission.

The embodiments of the present invention are not limited to the above-mentioned embodiments, and various modifications are possible within the scope of the claims. Thus, embodiments obtained by combining technical means modified appropriately within the scope defined by claims are included in the technical scope of the present invention.

### CROSS-REFERENCE OF RELATED APPLICATION

The present application claims priority based on Japanese Patent Application No. 2017-104368 filed on May 26, 2017, all of the contents of which are incorporated herein by reference.

### INDUSTRIAL APPLICABILITY

The embodiments of the present invention can be preferably applied to an image decoding apparatus to decode coded data where image data is coded, and an image coding apparatus to generate coded data where image data is coded. The embodiments of the present invention can be preferably applied to a data structure of coded data generated by the image coding apparatus and referred to by the image decoding apparatus.

### REFERENCE SIGNS LIST

10 CT information decoding unit
11 Image coding apparatus
20 CU decoding unit
31 Image decoding apparatus
41 Image display apparatus

1: A video coding apparatus configured to code an input video, the video coding apparatus comprising:
a memory and
a processor, wherein the processor configured to perform steps of:
splitting a picture of the input video to a block including multiple pixels;
by taking the block as a unit, referring to a pixel (a reference pixel) of an adjacent block of a target block, performing an intra prediction and calculating a prediction pixel value;
subtracting the prediction pixel value from the input video and calculating a prediction error;
performing transformation and quantization on the prediction error and output a quantized transform coefficient; and
performing variable-length coding on the quantized transform coefficient,
wherein the processor further comprising to perform steps of:
referring to a pixel of a block on a left side and a pixel of a block on an upper side, of the target block on which the intra prediction is performed;
referring to, in the chrominance component, for a reference pixel of the block on the upper side, one pixel (a first reference pixel) for every two pixels of the target block;
deriving a remaining one pixel (a second reference pixel) by interpolation from the first reference pixel;
referring to the first reference pixel and the second reference pixel; and
calculating an intra prediction value of each pixel of the chrominance component of the target block.

2: The video coding apparatus according to claim 1,
wherein the first reference pixel is a pixel at an odd-numbered pixel position, and
the second reference pixel is a pixel at an even-numbered pixel position.

3: The video coding apparatus according to claim 1,
wherein the first reference pixel is a pixel at an even-numbered pixel position, and
the second reference pixel is a pixel at an odd-numbered pixel position.

4: A video decoding apparatus configured to decode a video, the video decoding apparatus comprising:
a memory and
a processor, wherein the processor configured to perform steps of:
by taking a block including multiple pixels as a processing unit, performing variable-length decoding on coded data and outputting a quantized transform coefficient;
performing inverse quantization and inverse transformation on the quantized transform coefficient and outputting a prediction error;
by taking the block as a unit, referring to a pixel (a reference pixel) of an adjacent block of a target block, performing an intra prediction, and calculating a prediction pixel value; and
adding the prediction pixel value and the prediction error,
wherein the processor further comprising to perform steps of:
referring to a pixel of a block on a left side and a pixel of a block on an upper side, of the target block on which the intra prediction is performed;
referring to, in the chrominance component, for a reference pixel of the block on the upper side, one pixel (a first reference pixel) for every two pixels of the target block;
deriving a remaining one pixel (a second reference pixel) by interpolation from the first reference pixel;
referring to the first reference pixel and the second reference pixel; and
calculating an intra prediction value of each pixel of the chrominance component of the target block.

5: The video decoding apparatus according to claim 4,
wherein the first reference pixel is a pixel at an odd-numbered pixel position, and
the second reference pixel is a pixel at an even-numbered pixel position.

6: The video decoding apparatus according to claim 4,
wherein the first reference pixel is a pixel at an even-numbered pixel position, and
the second reference pixel is a pixel at an odd-numbered pixel position.

7: A video decoding apparatus configured to decode a video, the video decoding apparatus comprising:
a variable-length decoding circuit configured to, by taking a block including multiple pixels as a processing unit, perform variable-length decoding on coded data and output a quantized transform coefficient;
an inverse quantization and inverse transformation circuit configured to perform inverse quantization and inverse transformation on the quantized transform coefficient and output a second prediction error;
a predictor configured to, by taking the block as a unit, refer to a pixel (a reference pixel) of an adjacent block of a target block, perform an intra prediction, and calculate a prediction pixel value;
an adding circuit configured to add the prediction pixel value and the prediction error and derive a decoded image; and
a filter configured to perform filtering on the decoded image,
wherein in the predictor or the filter, processing to be performed in a case that a block boundary is a CU boundary is different from processing to be performed in a case that the block boundary is a CTU boundary.

8: A video coding apparatus configured to code an input video, the video coding apparatus comprising:
a splitting circuit configured to split a picture of the input video to a block including multiple pixels;
a predictor configured to, by taking the block as a unit, refer to a pixel (a reference pixel) of an adjacent block of a target block, perform an intra prediction, and calculate a prediction pixel value;
a subtracting circuit configured to subtract the prediction pixel value from the input video and calculate a first prediction error;
a transformation and quantization circuit configured to perform transformation and quantization on the prediction error and output a quantized transform coefficient;
a variable-length coding circuit configured to perform variable-length coding on the quantized transform coefficient;
an inverse quantization and inverse transformation circuit configured to perform inverse quantization and inverse transformation on the quantized transform coefficient and output a second prediction error;
an adding circuit configured to add the prediction pixel value and the prediction error and derive a decoded image; and
a filter configured to perform filtering on the decoded image,
wherein in the predictor or the filter, processing to be performed in a case that a block boundary is a CU boundary is different from processing to be performed in a case that the block boundary is a CTU boundary.
